(19) United States
(12) Patent Application Publication
(10) Pub. No.: US 2020/0175506 A1
(43) Pub. Date: Jun. 4, 2020

(54) Conversion of Cryptocurrencies

(71) Applicant: Factom, Inc., Austin, TX (US)

(72) Inventor: Paul Snow, Austin, TX (US)

(73) Assignee: Factom, Inc., Austin, TX (US)

(21) Appl. No.: 16/695,272

(22) Filed: Nov. 26, 2019

Related U.S. Application Data
(60) Provisional application No. 62/895,520, filed on Sep. 4, 2019.
(60) Provisional application No. 62/907,862, filed on Sep. 30, 2019.
(60) Provisional application No. 62/774,357, filed on Dec. 3, 2018.

(51) Int. Cl. G06Q 20/38; G06Q 20/36; G06Q 20/06; G06Q 40/04; H04L 9/32

(52) U.S. Cl. CPC G06Q 20/381; G06Q 20/3672; G06Q 20/0655; H04L 2209/56; H04L 9/3213; G06Q 2220/00; G06Q 40/04

(57) ABSTRACT

Owners/Holders of different cryptographic coinages may buy, sell, trade, or otherwise convert different cryptographic coinages via an intermediary in a decentralized manner. Multiple and different cryptographic tokens may be pegged to different assets. The different cryptographic tokens are value related based on cryptographic exchange rates. Whenever an individual user or owner requests a market transaction (such as a buy or sell order), at least one of a destruction operation and a creation operation are performed. The destruction operation destroys or removes at least one of the cryptographic tokens, while the creation operation creates or injects new ones of a different cryptographic token. Owners/Holders may thus exchange or convert between different cryptographic assets, depending on their restive values and exchange rates.

### CROSS-REFERENCE TO RELATED APPLICATIONS

This application claims domestic benefit of U.S. Provisional Application No. 62/895,520 filed Sep. 4, 2019 and incorporated herein by reference in its entirety. This application also claims domestic benefit of U.S. Provisional Application No. 62/907,862 filed Sep. 30, 2019 and incorporated herein by reference in its entirety. This application also claims domestic benefit of U.S. Provisional Application No. 62/774,357 filed Dec. 3, 2018 and incorporated herein by reference in its entirety. This application also relates to U.S. application Ser. No. 16/351,592 filed Mar. 13, 2019 and incorporated herein by reference in its entirety. This application also relates to U.S. application Ser. No. 16/191,595 filed Nov. 15, 2018 and incorporated herein by reference in its entirety. This application also relates to U.S. Provisional Application No. 62/723,595 filed Aug. 28, 2018 and incorporated herein by reference in its entirety. This application also relates to U.S. Provisional Application No. 62/714,909 filed Aug. 6, 2018 and incorporated herein by reference in its entirety. This application also relates to U.S. Provisional Application No. 62/714,911 filed Aug. 6, 2018 and incorporated herein by reference in its entirety.

### BACKGROUND

Cryptographic coinage and blockchains are growing in usage. As usage grows, however, volatility has become a problem. The markets for cryptographic coinage have become highly speculative and extreme price variations are hindering mainstream adoption.

### BRIEF DESCRIPTION OF THE SEVERAL VIEWS OF THE DRAWINGS

The features, aspects, and advantages of the exemplary embodiments are understood when the following Detailed Description is read with reference to the accompanying drawings, wherein:

FIG. 1 illustrates a cryptocurrency gateway server, according to exemplary embodiments;

FIGS. 2-5 illustrate cryptocurrency operations, according to exemplary embodiments;

FIG. 6 illustrates blockchaining, according to exemplary embodiments;

FIG. 7 illustrates a blockchain data layer, according to exemplary embodiments;

FIG. 8 illustrates reserving and addressing, according to exemplary embodiments;

FIGS. 9-10 illustrate multiple cryptocurrency assets, according to exemplary embodiments;

FIGS. 11-13 are simple illustrations of asset conversion, according to exemplary embodiments;

FIG. 14 illustrates a transactional process for asset conversions, according to exemplary embodiments;

FIGS. 15-17 are more detailed illustrations of an operating environment, according to exemplary embodiments;

FIG. 18 illustrates indexing of cryptographic coinage, according to exemplary embodiments;

FIG. 19 illustrates blockchain recordations, according to exemplary embodiments;

FIGS. 20-27 further illustrate the blockchain data layer, according to exemplary embodiments;

FIG. 28 is a flowchart illustrating a method or algorithm for converting cryptographic assets; and

FIGS. 29-30 illustrate additional operating environments, according to exemplary embodiments.

### DETAILED DESCRIPTION

The exemplary embodiments will now be described more fully hereinafter with reference to the accompanying drawings. The exemplary embodiments may, however, be embodied in many different forms and should not be construed as limited to the embodiments set forth herein. These embodiments are provided so that this disclosure will be thorough and complete and will fully convey the exemplary embodiments to those of ordinary skill in the art. Moreover, all statements herein reciting embodiments, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating the exemplary embodiments. The functions of the various elements shown in the figures may be provided through the use of dedicated hardware as well as hardware capable of executing associated software. Those of ordinary skill in the art further understand that the exemplary hardware, software, processes, methods, and/or operating systems described herein are for illustrative purposes and, thus, are not intended to be limited to any particular named manufacturer.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, etc. may be used herein to describe various elements, these elements should not be limited by these terms. These terms are only used to distinguish one element from another. For example, a first device could be termed a second device, and, similarly, a second device could be termed a first device without departing from the teachings of the disclosure.

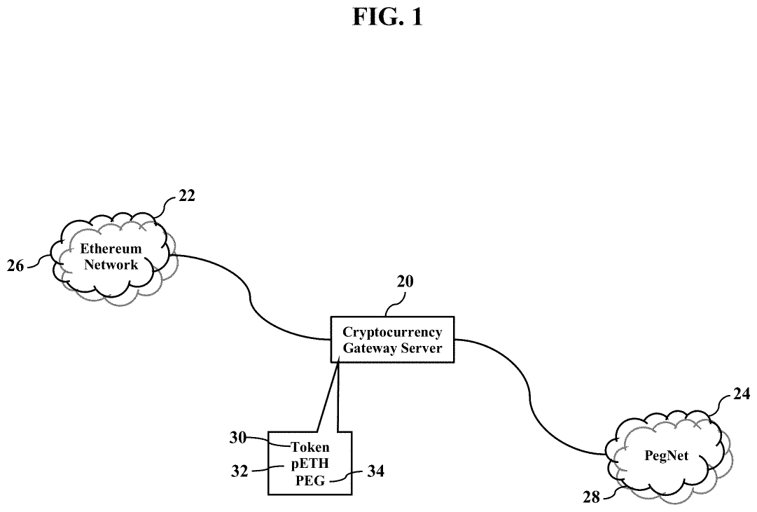

FIG. 1 illustrates a cryptocurrency gateway server 20, according to exemplary embodiments. The cryptocurrency gateway server 20 functionally acts as a network intermediary between any two (2) or more different cryptocurrency systems/networks. FIG. 1, for example, illustrates the cryptocurrency gateway server 20 networked between a first cryptocurrency network 22 and a different, second cryptocurrency network 24. While the first cryptocurrency network 22 and the second cryptocurrency network 24 may be affiliated with any cryptocurrencies, many readers may be familiar with the ETHEREUM® network 26 and a separate network 28 of pegged tokens (or “PegNet”). As the reader may understand, each pegged cryptographic token in the network 28 of pegged tokens may be tied (or “pegged”) to any tradeable asset, such as any currency (e.g., the US Dollar, the Chinese Yen, the Euro), a commodity (e.g., oil, gold, silver), or property (e.g., real estate, intellectual, jewelry, antiques). Each pegged cryptographic token may thus have its corresponding current market value and may also have its corresponding target value. When any cryptocurrency token 30 (such as the pooled ETHEREUM® token or “pETH” 32) is transferred, traded, converted, and/or exchanged between the first cryptocurrency network 22 and the second cryptocurrency network 24, the cryptocurrency gateway server 20 may intercept, manage, and even conduct any or all transactions. Similarly, should any pegged token (or “PEG”) 34 be transferred, traded, converted, and/or exchanged between the network 28 of pegged tokens and the first cryptocurrency network 22 (e.g., the ETHEREUM® network 26), the cryptocurrency gateway server 20 may manage or even conduct any or all transactions. The cryptocurrency gateway server 20 may thus function as a middleware and/or network element that brokers cryptographic transactions between the cryptocurrency systems/networks.

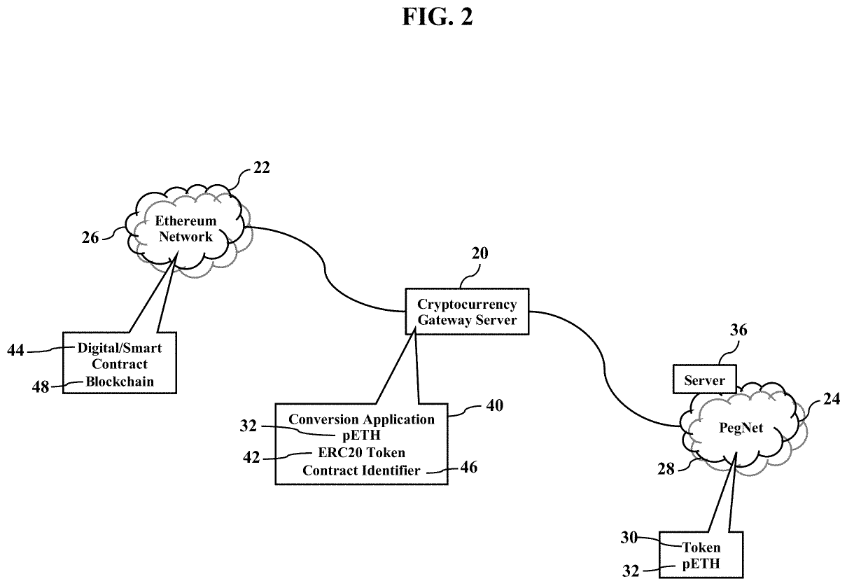

FIGS. 2-5 illustrate cryptocurrency operations, according to exemplary embodiments. Suppose, for example, that the pETH token 32 needs to be transferred, traded, converted, and/or exchanged from the network 28 of pegged tokens to the ETHEREUM® network 26. Any device (such as a server 36) in the network 28 of pegged tokens sends/routes the pETH token 32 (and/or information describing the pETH token 32) via a communications network to a network address (e.g., Internet Protocol address) associated with the cryptocurrency gateway server 20. The cryptocurrency gateway server 20 has a processor (e.g., “μP”), application specific integrated circuit (ASIC), or other component that executes a conversion application 40 stored in a local, solid-state memory device. The cryptocurrency gateway server 20 has one or more network interfaces (not shown for simplicity) to the ETHEREUM® network 26 and to the network 28 of pegged tokens, thus allowing two-way, bidirectional communication. The conversion application 40 includes instructions, code, and/or programs that cause the cryptocurrency gateway server 20 to perform operations, such as receiving the pETH token 32 and creating an ERC20-compatible cryptographic token 42 for the ETHEREUM® network 26. The ERC20-compatible cryptographic token 42 may specify or be associated with one or more digital or smart contracts 44 (such as a contract identifier 46). As the reader may understand, ERC-20 is a known technical standard describing logical rules used for executing smart contracts on, by, or within the ETHEREUM® network 26 (such as the ETHEREUM® blockchain 48).

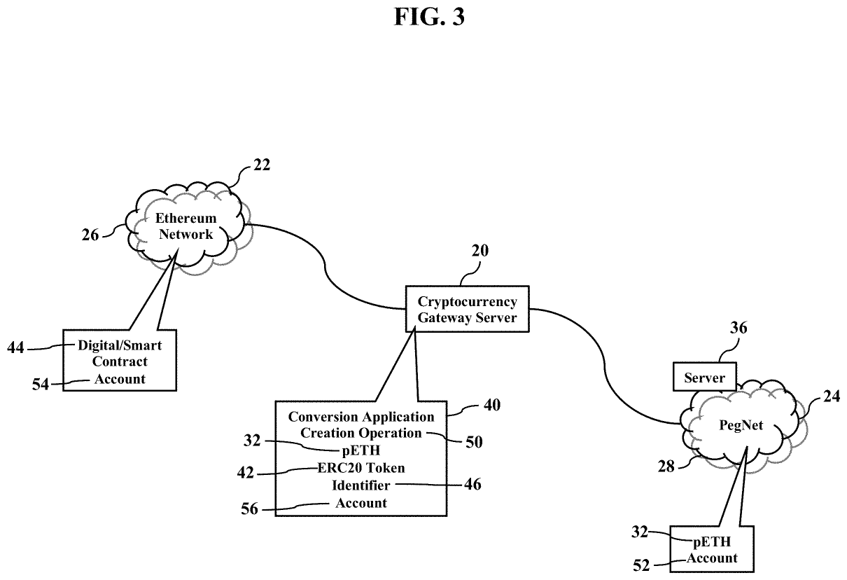

As FIG. 3 illustrates, a creation operation 50 may be performed. When the cryptocurrency gateway server 20 receives the pETH token 32, the conversion application 40 causes the cryptocurrency gateway server 20 to perform the creation operation 50. That is, because the network 28 of pegged tokens is attempting to transfer/move/trade/convert/exchange the pETH token 32 from an account address 52 in the network 28 of pegged tokens to an account address 54 in the ETHEREUM® network 26, the conversion application 40 causes the cryptocurrency gateway server 20 to perform the creation operation 50. The cryptocurrency gateway server 20, for example, may read or inspect the account address 54 and compare to a list or database of account addresses known to exist in, or be associated with, the ETHEREUM® network 26. Should the account address 54 match an entry associated with the ETHEREUM® network 26, then perhaps the cryptocurrency gateway server 20 performs the creation operation 50. The conversion application 40 causes the cryptocurrency gateway server 20 to create the ERC20-compatible cryptographic token 42 (perhaps created in the network 28 of pegged tokens), but the ERC20-compatible cryptographic token 42 is also compatible with the ETHEREUM® network 26. The cryptocurrency gateway server 20 may further create the ERC20-compatible cryptographic token 42 according to any target value, cryptographic exchange rate, market value, or other pricing requirement. Because the cryptocurrency gateway server 20 creates the ERC20-compatible cryptographic token 42 for the ETHEREUM® network 26, the ERC20-compatible cryptographic token 42 may further specify, or be associated with, the account address 54 in the ETHEREUM® network 26. Moreover, the cryptocurrency gateway server 20 may further specify or associate the ERC20-compatible cryptographic token 42 to the contract identifier 46 that identifies the digital or smart contract 44 that executes in the ETHEREUM® network 26. The cryptocurrency gateway server 20 logs the creation operation 50 to relate or identify the pETH token 32 to the ERC20-compatible cryptographic token 42. Moreover, perhaps at nearly the same time (contemporaneously or perhaps nearly simultaneously), the cryptocurrency gateway server 20 moves or transfers the pETH token 32 from the owner's account address 54 (associated with the network 28 of pegged tokens) to a private or undisclosed account address 56 only known to and/or only accessible to the cryptocurrency gateway server 20. The cryptocurrency gateway server 20 may thus effectively quarantine or confine the pETH token 32 to the account address 56 unknown and/or inaccessible to either the network 28 of pegged tokens and/or the ETHEREUM® network 26. The cryptocurrency gateway server 20 may send or route the ERC20-compatible cryptographic token 42 into the ETHEREUM® network 26 for delivery to, or for association with, the account address 54 in the ETHEREUM® network 26.

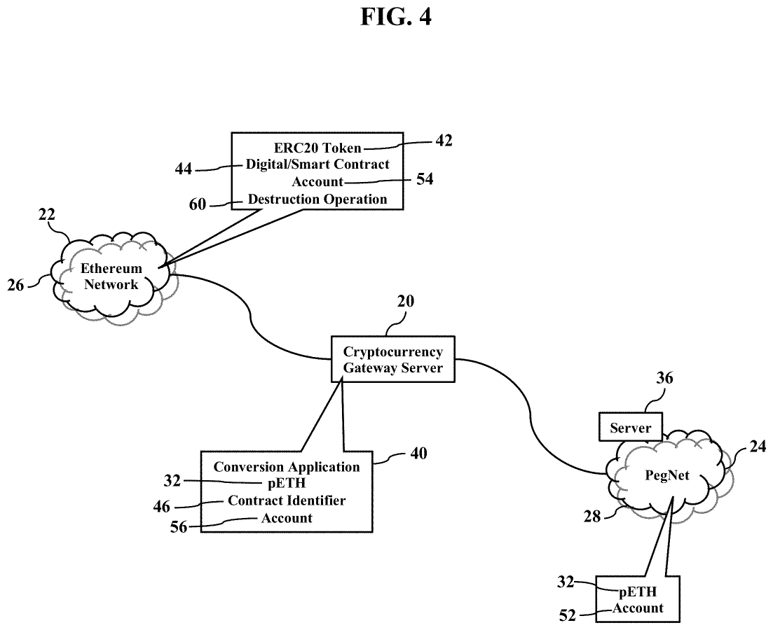

As FIG. 4 illustrates, a destruction operation 60 may be performed. Once the ERC20-compatible cryptographic token 42 enters or is admitted to the ETHEREUM® network 26, at a later time the ETHEREUM® network 26 may attempt to transfer/move/trade/convert/exchange the ERC20-compatible cryptographic token 42 back to the network 28 of pegged tokens. However, recall that the ERC20-compatible cryptographic token 42 is associated with the contract identifier 46 that identifies the digital or smart contract 44 that executes in the ETHEREUM® network 26. The ETHEREUM® network 26 thus performs the destruction operation 60, as specified by the digital or smart contract 44. For example, any device in the ETHEREUM® network 26 may be assigned execution of the digital or smart contract 44. The ETHEREUM® network 26 may additionally or alternatively read or inspect the account address 52 and compare to a list or database of account addresses known to exist in, or be associated with, the network 28 of pegged tokens. Should the account address 52 match an entry associated with the network 28 of pegged tokens, then the ETHEREUM® network 26 (such as the ETHEREUM® source blockchain 48 illustrated in FIG. 1) is programmed to execute the digital or smart contract 44. Regardless, the digital or smart contract 44 causes any server or other device in the ETHEREUM® network 26 (perhaps even the cryptocurrency gateway server 20) to execute or perform the destruction operation 60 to destroy the ERC20-compatible cryptographic token 42. Moreover, perhaps at nearly the same time (contemporaneously or perhaps nearly simultaneously), the cryptocurrency gateway server 20 moves or transfers the ERC20-compatible cryptographic token 42 and/or its value from the owner's account address 54 (associated with an owner in the ETHEREUM® network 26) to the account address 56 only known to and/or only accessible to the cryptocurrency gateway server 20. The destruction operation 60 thus removes or destroys the ERC20-compatible cryptographic token 42 from being transferred/moved/traded/converted/exchanged to the network 28 of pegged tokens. The cryptocurrency gateway server 20 effectively prohibits or blocks the ERC20-compatible cryptographic token 42 from re-entering the network 28 of pegged tokens, thus ensuring that the ERC20-compatible cryptographic token 42 will no longer effectively exist on the PegNet side 28, and the ERC20-compatible cryptographic token 42 may only exist on the Ethereum side. The cryptocurrency gateway server 20 thus uses and/or specifies the digital or smart contract 44 (or any other mechanism) on the Ethereum side to ensure any token 30 created for or brought to the Ethereum side is destroyed when brought back to the PegNet. The cryptocurrency gateway server 20 thus ensures that there is only ever a single instance of the ERC20-compatible cryptographic token 42 across both networks (e.g., the ETHEREUM® network 26 and the network 28 of pegged tokens).

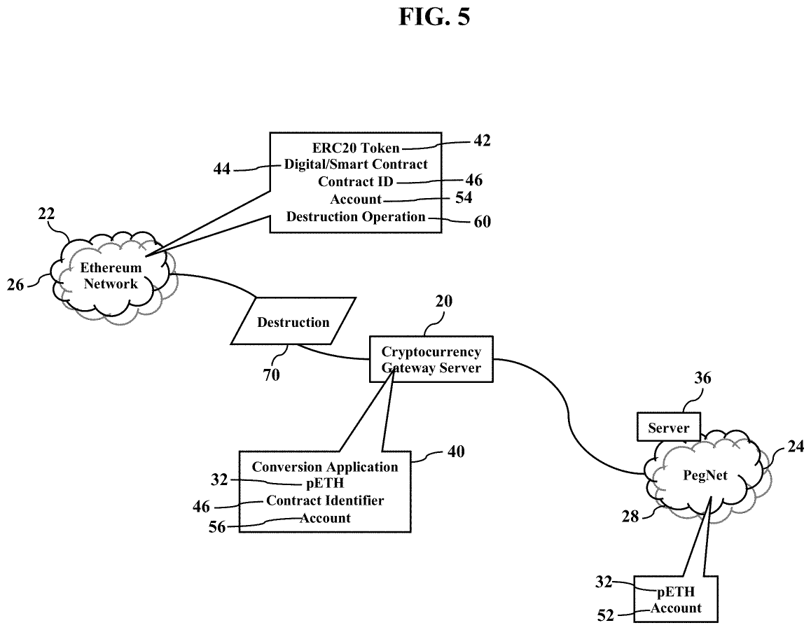

FIG. 5 further illustrates the destruction operation 60. When any cryptographic token (such as the ERC20-compatible cryptographic token 42) is sent from the ETHEREUM® network 26 to the network 28 of pegged tokens, any server or other device in the ETHEREUM® network 26 may read the contract identifier 46 and execute the corresponding digital or smart contract 44 that destroys the ERC20-compatible cryptographic token 42 (according to the destruction operation 60). The ETHEREUM® network 26 may send a destruction notification or message 70 to the IP address associated with the cryptocurrency gateway server 20. The destruction notification or message 70 contains information or data that confirms or acknowledges the ERC20-compatible cryptographic token 42 was destroyed in the ETHEREUM® network 26. In response to a receipt of the destruction notification or message 70, the cryptocurrency gateway server 20 may move or transfer the pETH token 32 (and/or its cryptographic value) from the account address 56 (known only to and/or only accessible to the cryptocurrency gateway server 20) to the account address 52 associated with the owner in the network 28 of pegged tokens. The cryptocurrency gateway server 20, in other words, releases or reissues the pETH token 32 that was previously quarantined, confined, or restricted to the account address 56. The cryptocurrency gateway server 20 may thus use the account address 56 as a confinement or quarantine electronic wallet as a stability mechanism in the network 28 of pegged tokens.

The cryptocurrency gateway server 20 may cooperate with edge servers. Devices associated with the first cryptocurrency network 26 (such as routers, firewalls, switches, and servers affiliated with the ETHEREUM® network 26) may thus store or access routing tables and other networking information that maps or identifies the cryptocurrency gateway server 20 as a network gateway destination for network/packet/IP traffic into the network 28 of pegged tokens. As an example, an edge server may operate in, or be associated with, the ETHEREUM® network 26. The devices affiliated with the ETHEREUM® network 26 may be programmed to route all packet traffic associated with ERC20-compatible cryptographic token 42 to the edge server as a destination. The edge server may thus act or function as a network consolidation element for any traffic destined for the network 28 of pegged tokens. The edge server may thus forward or send the network traffic to the cryptocurrency gateway server 20. Devices associated with the network 28 of pegged tokens may additionally store or access routing tables and other networking information that maps or identifies the cryptocurrency gateway server 20 as a network gateway destination for network/packet/IP traffic into the ETHEREUM® network 26. An edge server operating in the network 28 of pegged tokens may collect or consolidate all packet traffic to the ETHEREUM® network 26 and forward or send the network traffic to the cryptocurrency gateway server 20. The cryptocurrency gateway server 20 thus acts as a single or central network resource for admitting/exiting data packets and network traffic to/from the network 28 of pegged tokens.

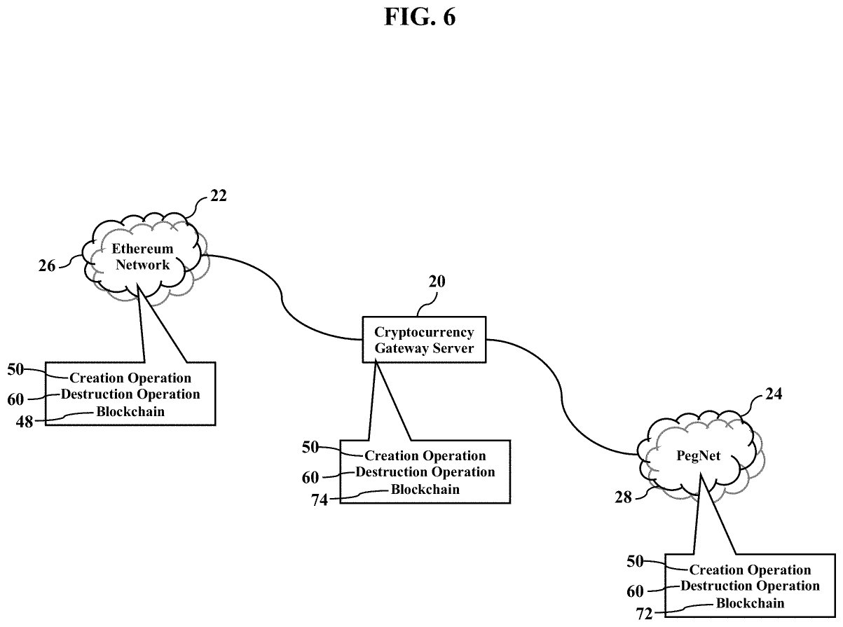

FIG. 6 illustrates blockchaining, according to exemplary embodiments. The network 28 of pegged tokens may record the creation operation 50 and/or the destruction operation 60 to a blockchain 72. The blockchain 72 may be dedicated to recording any cryptographic coinage transactions that involve or relate to the network 28 of pegged tokens. The ETHEREUM® network 26 may additionally or alternatively record the creation operation 50, the destruction operation 60, and/or any cryptographic coinage transactions (that involve or relate to the ETHEREUM® network 26) to the blockchain 48. Moreover, either one or both of the blockchains 48 and 72 may record the operations or activities of the cryptocurrency gateway server 20. The cryptocurrency gateway server 20 may even generate a dedicated blockchain 74 that records the creation operation 50 and/or the destruction operation 60.

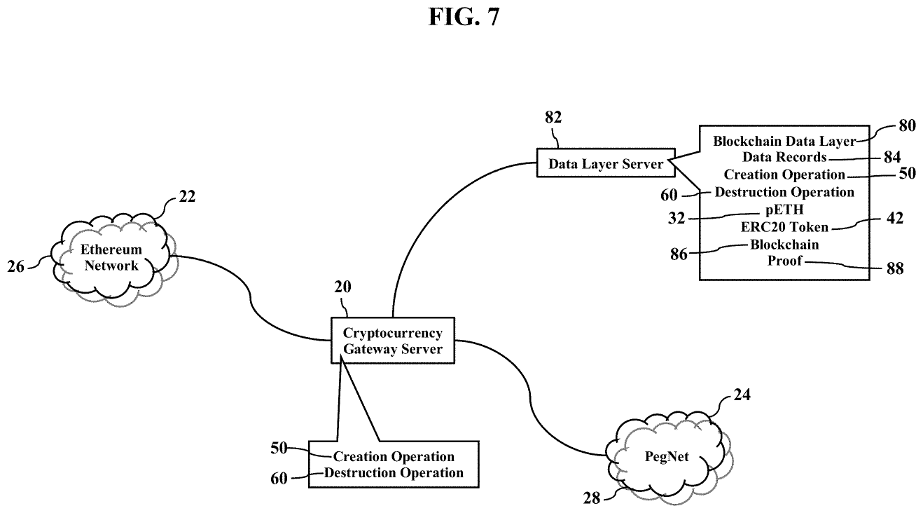

FIG. 7 illustrates a blockchain data layer 80, according to exemplary embodiments. The cryptocurrency gateway server 20 may update or inform a data layer server 82 that generates the blockchain data layer 80. The blockchain data layer 80 documents the creation operation 50 and the destruction operation 60 involving or associated with the pETH token 32 and the ERC20-compatible cryptographic token 42. The data layer server 82 may thus call, invoke, or apply a data layer application as a software module or subroutine that generates data records 84 in the blockchain data layer 80. Moreover, the blockchain data layer 80 may also add another layer of cryptographic hashing to generate a public blockchain 86. The blockchain data layer 80 acts as a validation service that validates the creation operation 50 and the destruction operation 60 were executed. Moreover, the blockchain data layer 80 may generate a cryptographic proof 88 and publish the cryptographic proof 88 as a public ledger that establishes chains of blocks of immutable evidence.

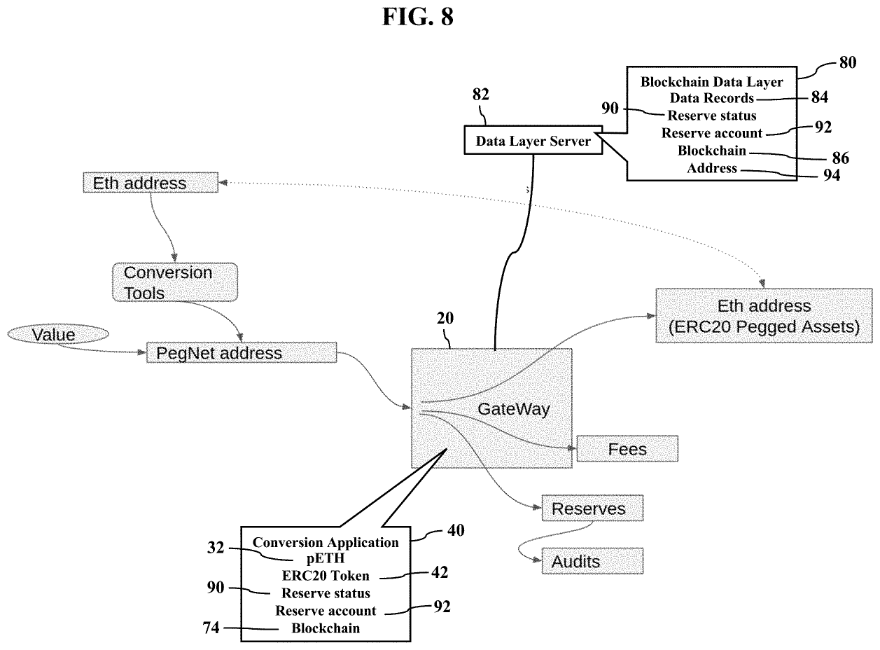

FIG. 8 illustrates reserving and addressing, according to exemplary embodiments. When the cryptocurrency gateway server 20 receives any asset (such as the pETH token 32 and/or the ERC20-compatible cryptographic token 42), the cryptocurrency gateway server 20 may cryptographically move or divert the asset to reserves (such as a reserve status 90 and/or a reserve account 92). The reserve status 90 and/or the reserve account 92 may be recorded to, and auditable from, the blockchain 74. The reserve status 90 and/or the reserve account 92 may additionally or alternatively be recorded to, and auditable from, the data records 84 in the blockchain data layer 80. The data records 84 in the blockchain data layer may thus log or track any coin amounts moved to exchanges, any coin amounts removed from any cryptocurrency network, and any amounts received from exchanges or cryptocurrency networks. At the same time, the ERC20-compatible cryptographic token(s) 42 are issued to an address 94 derived from the same public key used by the address assigned by the blockchain data layer 80. A client-side or user-side software application (such as an electronic wallet or other mobile application stored and executed by a smartphone, tablet, or other user's device) provides interfaces into ETHEREUM® wallets to import such addresses; conversely, such software tooling may take an ETHEREUM® address and create the needed Factom/PegNet addresses in the blockchain data layer 80.

The cryptocurrency gateway server 20 thus provides verification. An ETHEREUM® address/PegNet pair may be created (such as by the conversion application 40 or other software conversion tool) from an ETHEREUM® address (or Factom/PegNet address, for that matter). As assets come into the cryptocurrency gateway server 20, a combination of direct on chain accounting, and audit trails of arbitrage activities can be derived from the cryptocurrency gateway server 20 to verify assets and reserves. But the actual value those assets back comes from the ETC address (and issued ERC20 tokens) at that address. The ERC20-compatible cryptographic token(s) 42 can be created against the value created by deposits as shown, or can come from a liquidity pool of assets that are already backed by assets in the cryptocurrency gateway server 20. The ERC20-compatible cryptographic token(s) 42 may thus be issued from Pegged assets sent to the cryptocurrency gateway server 20.

The cryptocurrency gateway server 20 may thus execute the destruction operation 60. When the cryptocurrency gateway server 20 receives any request to conduct a cryptographic asset conversion, the cryptocurrency gateway server 20 may inspect the request to identify data or information specifying the cryptographic tokens 30 and/or 34 to be converted and any cryptographic addresses (e.g., tokens and/or electronic wallet). Suppose, for example, that a user wishes to convert a first cryptographic token 30a into a second cryptographic token 30b. The cryptographic tokens 30a-b are associated with, or issued by, different networks of cryptographic tokens (e.g., the ETHEREUM® token from the ETHEREUM® network and the BITCOIN® token from the BITCOIN® network). The cryptocurrency gateway server 20 sends a request to the ETHEREUM® network requesting the ETHEREUM® token(s) specified by the user's request to conduct the cryptographic asset conversion. The ETHEREUM® network sends the ETHEREUM® token(s) that are associated with the user's electronic wallet. When the cryptocurrency gateway server 20 receives the ETHEREUM® token(s), the cryptocurrency gateway server 20 executes the destruction operation 60 by removing, or destroying, the ETHEREUM® token(s) from the ETHEREUM® network and de-links, removes, or unassociates the ETHEREUM® token(s) from the user's electronic wallet. Moreover, the cryptocurrency gateway server 20 may divert the ETHEREUM® token(s) to the private reserve account 92 controlled by the cryptocurrency gateway server 20. The ETHEREUM® token(s), in other words, are removed from ownership or circulation within the ETHEREUM® network and, instead, linked to the private address 56 associated with the private reserve account 92 (known only to, and/or accessible by, the cryptocurrency gateway server 20). The cryptocurrency gateway server 20 may thus effectively remove and quarantine or confine the ETHEREUM® token(s) to the account address 56 unknown and/or inaccessible to the ETHEREUM® network.

The cryptocurrency gateway server 20 may also execute the creation operation 50. When the cryptocurrency gateway server 20 receives any request to conduct a cryptographic asset conversion, the cryptocurrency gateway server 20 may also execute the creation operation 50. The cryptocurrency gateway server 20, for example, may send a request to the BITCOIN® network requesting BITCOIN® token(s) specified by the user's request to conduct the cryptographic asset conversion. The BITCOIN® network sends a quantity of the BITCOIN® token(s), depending on current exchange rates and/or market values (as this disclosure will later explain). The cryptocurrency gateway server 20 may link, add, or associate the BITCOIN® token(s) to user's electronic wallet. The cryptocurrency gateway server 20 has thus performed an intermediary or middleware service that converts the ETHEREUM® token(s) into the BITCOIN® token(s).

The cryptocurrency gateway server 20 may also pull from the private reserve account 92. When the cryptocurrency gateway server 20 executes the creation operation 50, the cryptocurrency gateway server 20 may first check or inspect the private reserve account 92 for any cryptographic tokens to be created. That is, the private reserve account 92 may be associated with BITCOIN® token(s) that were previously or historically destructed (via a previous destruction operation 60). Because there may be BITCOIN® token(s) linked to the private address 56 associated with the private reserve account 92 (maintained under the control of cryptocurrency gateway server 20), the cryptocurrency gateway server 20 may first retrieve or acquire the BITCOIN® token(s) from the private reserve account 92 to satisfy the required quantity (again depending on current exchange rates and/or market values). If the quantity of the BITCOIN® token(s) from the private reserve account 92 are less than, or cannot satisfy, the required quantity, the cryptocurrency gateway server 20 may request additional or new BITCOIN® token(s) from the BITCOIN® network. The cryptocurrency gateway server 20 may then link, add, or associate the BITCOIN® token(s) to user's electronic wallet, thus designating and reinjecting the BITCOIN® token(s) back into the BITCOIN® network for circulation, ownership, and other trades. The cryptocurrency gateway server 20 has thus performed an intermediary or middleware service that converts the ETHEREUM® token(s) into the BITCOIN® token(s).

Addressing may be constant. The cryptocurrency gateway server 20 may receive any asset (such as the cryptographic token 32 received via the source blockchain 48 associated with the ETHEREUM® network). The cryptocurrency gateway server 20 may then transfer, trade, convert, and/or exchange the cryptographic token 32 to an equivalent value associated with the reserve account 92, associated with any destination blockchain (such as the blockchains 72 and/or 86 explained with reference to FIGS. 6-7), and/or associated with a different asset (such as the BITCOIN® token 30a, the LITECOIN® token 30b, the RAVENCOIN® token 30c, the BINANCE COIN® token 30d, and/or the pegged token 34, as this disclosure explains). When the cryptocurrency gateway server 20 brokers, manages, or conducts any cryptographic transaction, addressing may be constant. That is, the address (e.g., the private and/or public cryptographic key) associated with the source of the token asset 32 and/or the source blockchain 48 may match the address (e.g., the private and/or public cryptographic key) associated with the destination account 52 and/or the destination blockchain 72. Any movement of a cryptographic asset from the source to the destination may not involve a change of person or account, as the keys may be exactly the same cryptographically. Because any one or more blockchains (e.g., 48, 72, 74, and/or 86) may record any and/or every cryptographic transaction, any of the blockchains 48, 72, 74, and/or 86 may log the connection or mapping association of one address to the other address (e.g., source-to-destination). Because the cryptographic source and destination addresses are immutably written to at least one blockchain, there is no way to launder money or to obscure the ownership of the payment to the tokens received. The blockchain thus records and documents a cryptographic proof of no change in the basis of value, and no change of the nominal value aside from the fee charged occurs while crossing the cryptocurrency gateway server 20.

Electronic wallets may be synchronized. Because the source and destination addresses may be equal or matching, the source and destination electronic wallets (associated with buyer/seller/converter/user) may be synchronized. That is, the source and destination electronic wallets may use the same cryptographic seed keys for address generation. By using the same key generation seed in electronic wallet(s) on both blockchains/accounts allows assets issued to the common source/destination address to appear in electronic wallets on the destination blockchain. In other words, when a user sends assets to the cryptocurrency gateway server 20 using a first or source address A, the assets received from the cryptocurrency gateway server 20 just appear in the electronic wallet on the second or destination blockchain with the same address A. Any code reading or inspecting blocks or data on the source and/or destination blockchains, without any additional information from the user, or the cryptocurrency gateway server 20, may retrieve data or information representing the tokens on the source blockchain 1 entering the cryptocurrency gateway server 20 with address A, and the new representation of the tokens appearing on the destination blockchain 2 in the same address A. The address at the source may be the same address at the destination, even if they are associated with two different blockchains.

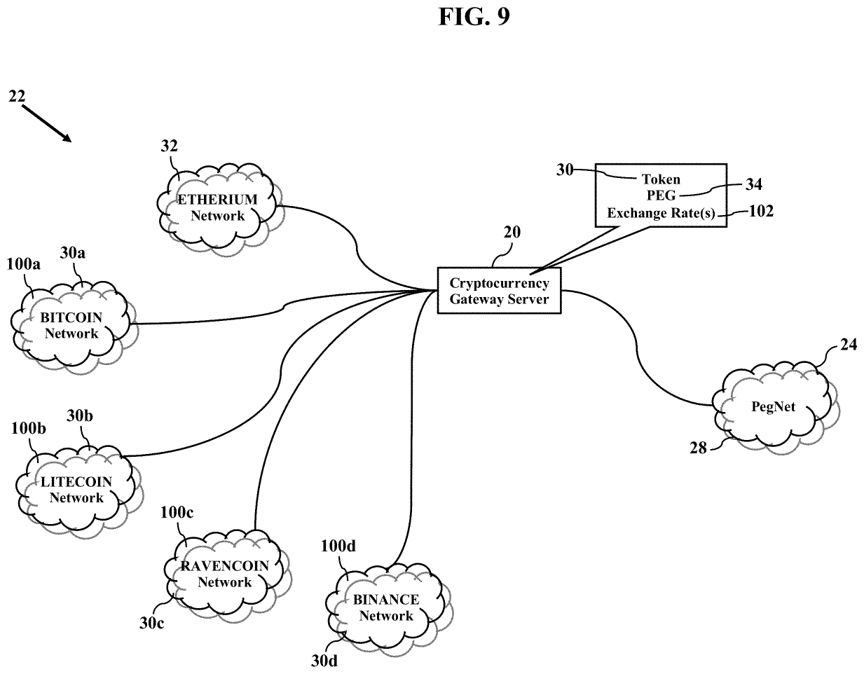

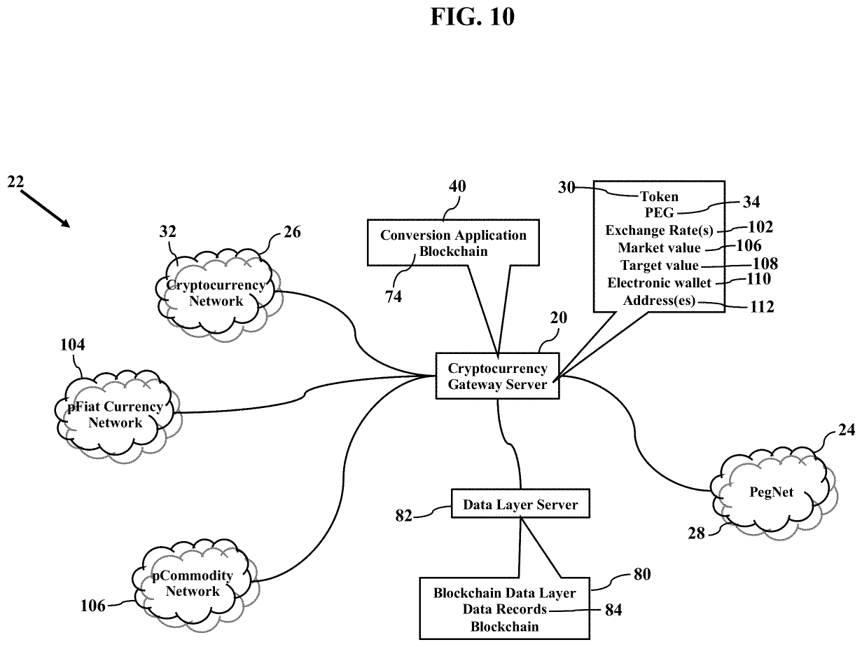

FIGS. 9-10 illustrate multiple assets, according to exemplary embodiments. The cryptocurrency gateway server 20 may act as a network intermediary between multiple, different cryptocurrency systems/networks. As this disclosure above explained, the cryptocurrency gateway server 20 may interface with the ETHEREUM® network 26 and the network 28 of pegged tokens. The cryptocurrency gateway server 20 may interface with the BITCOIN® network 100a, the LITECOIN® network 100b, the RAVENCOIN® network 100c, and/or the BINANCE COIN® network 100d. Indeed, whatever the cryptocurrency network 22, the cryptocurrency gateway server 20 may broker and conduct any transactions to/from or by/between any cryptographic tokens. For example, the cryptocurrency gateway server 20 may convert the value of the ETHEREUM® token 32 into a corresponding value of the pegged token 34 and, vice versa, convert the pegged token 34 into the ETHEREUM® token 32. The cryptocurrency gateway server 20 may also convert the value of the BITCOIN® token 30a into a corresponding value of the pegged token 34 and vice versa. However, the cryptocurrency gateway server 20 may also convert the value of the LITECOIN® token 30b into the pegged token 34, into the BITCOIN® token 30a, or into any combination of the RAVENCOIN® token 30c and the BINANCE COIN® token 30d. The cryptocurrency gateway server 20 may also convert the value of the ETHEREUM® token 32 into an equivalent, combined value of the pegged token 34 and the BITCOIN® token 30a. Whatever the cryptographic token 30, the cryptocurrency gateway server 20 may store and/or retrieve one or more exchange rates 102 that define or establish relative values between different cryptographic token(s). The exchange rates 102 allow the value of any cryptographic token 30 to be determined, converted, and/or exchanged into another one of the cryptographic tokens 30 and/or 34 and vice versa.

FIG. 10 illustrates additional assets. The cryptocurrency gateway server 20 may communicate with any server, router, device, or other element associated with the cryptocurrency network 22. The cryptocurrency gateway server 20 may also communicate with any server, router, device, or other element associated with the network 28 of pegged tokens. The cryptocurrency gateway server 20 may also communicate with any server, router, device, or other element associated with a pegged fiat (or “pFiat”) currency network 104. The pfiat currency network 104 sends, receives, and/or conducts transactions associated with any cryptocurrency token that is pegged to a fiat currency. The pfiat currency network 104, for example, may send information related to, or describing, orders, debits, deposits, withdrawals, and other cryptographic transactions specifying USDollars, Euros, Japanese Yens, British Pounds Sterlings, Canadian Dollars, Swiss Francs, and/or any other fiat currencies. The cryptocurrency gateway server 20 may also communicate with any server, router, device, or other element associated with a pegged commodity network 106. The commodity network 106 sends, receives, and/or conducts transactions associated with a commodity. The commodity network 106, for example, may send information related to, or describing, orders, debits, deposits, withdrawals, and other transactions specifying gold, silver, oil, minerals, foods, and any other commodities. Whatever the cryptographic token 30, and whatever the pegged fiat currency and/or commodity, the cryptocurrency gateway server 20 may store and/or retrieve one or more of the exchange rates 102 that define or establish relative values between different cryptographic token(s) 30 and 34.

The cryptocurrency gateway server 20 may manage asset transactions. Whatever the transaction(s), and whatever the cryptographic asset(s), the cryptocurrency gateway server 20 may intercept, manage, and even conduct any or all transactions. The exchange rates 102 allow the value of any cryptographic asset to be determined, converted, and/or exchanged into another, different cryptographic asset. Each cryptographic asset may thus have its corresponding current market value 106 and/or its corresponding target value 108. When any asset is transferred, traded, converted, and/or exchanged, the cryptocurrency gateway server 20 may intercept, manage, and even conduct any or all transactions. The cryptocurrency gateway server 20 may thus function as a middleware, network element, and/or service that brokers transactions between any cryptographic token(s) 30 and 34.

The multiple assets may be traded. Any cryptographic token(s) 30 and/or 34 may be bought, sold, traded, and/or converted. Any of the cryptographic token(s) 30 and/or 34 may be exchanged between any other, and/or to any other, according to their relative exchange rates 102. Any of the cryptographic token(s) 30 and/or 34 may be exchanged into an equivalent value of a combination of any other cryptographic token(s) 30 and/or 34. In other words, the ETHEREUM® token 32 may be converted into an equivalent value of the BITCOIN® token 32, according to the exchange rates 102. The ETHEREUM® token 32 may also be converted into an equivalent value of the pegged token 34, the BITCOIN® token 32, and the LITECOIN® token 32, depending on transaction specifications. Moreover, the cryptocurrency gateway server 20 may convert or exchange the pfiat currency token 30 and/or the pcommodity token 30 into an equivalent value of any one or combination of other cryptographic token(s) 30 and/or 34. Because the assets may fluctuate in value, there may be multiple exchange rates 102 when valuing/trading/converting between any of the assets. Even though the current market value 106 of the asset may fluctuate, the cryptographic token(s) 30 may have zero arbitrage opportunities. That is, its current market value 106 of the cryptographic token 30 is variable and may fluctuate. The current market value 106 of the cryptographic pegged tokens 34, however, may be constant or may vary. Traders will thus act on arbitrage opportunities (e.g., buy/sell/exchange) in response to the current market value 106 of an asset exceeding its target value 108. Users/Traders may trade/convert/sell one asset into another asset to reap a profit.

Asset conversions may be associated with an electronic wallet 110. The electronic wallet 110 stores, references, or links a user's asset holdings. The electronic wallet 110, in other words, associates information describing or specifying the user's asset holdings. The electronic wallet 110 may also be associated with an address 112 (such as a public cryptographic key and/or a private cryptographic key). Each cryptographic token 30 and/or 34 may also be associated with its corresponding address. The cryptocurrency gateway server 20 may conduct any asset transactions or conversions, and/or the asset transactions or conversions may be conducted inside or within the user's electronic wallet 110. Any cryptographic transactions may thus reference or specify the address associated with the wallet 110 and/or the cryptographic token 30 and 34.

The network 28 of pegged tokens may thus be a distributed, autonomous protocol. The protocol may be executed within, or run on top of, the blockchain data layer 80. The cryptocurrency gateway server 20, the network 28 of pegged tokens, and/or the user's electronic wallet 110 may store the value(s) of the user's asset holdings. The user may thus adjust his/her exposure to any asset without a counterparty or market exchange. Each user, in other words, may choose her/his exposure to the assets payment reel. No matter what assets the user holds, the user may automatically convert, without counterparty or exchange, to other cryptographic assets (e.g., pUSD tokens, to pEuro tokens, and/or to whatever some other party wishes to receive). Because the assets and the conversions may involve cryptographic transactions, any and/or all of the cryptographic transactions may be recorded to the blockchain 86 and audited. Moreover, any and/or all of the cryptographic transactions may be recorded to the data records 84 in the blockchain data layer 80. Digital or smart contracts may not be needed, so the cryptographic transactions are regulatorily compliant and autonomously executed and distributed.

The user may select from a selection of assets. As this disclosure above explained, the pegged token 34 may represent, or be tied to, the value of any asset (e.g., any individual or combination of the cryptographic token(s) 30, any individual or combination of the fiat currencies, and/or any individual or combination of the commodities). Mining may be used to distribute the process of collecting pricing information so all the miners submit their prices. Proof of work may be used to trim down, select, or filter a subset of the miners. Agreement between the miners may be used to decide where the shelling point is (that is, the price or value at which the miners agree, perhaps within some range or tolerance). The minors, or oracles, may be rewarded by earning portions of or whole pegged tokens 34 in exchange for mining, proof of work, and/or consensus. The cryptographic transactions may send the assets peer-to-peer without a counterparty or market exchange. The cryptographic transactions exhibit no gaming. In other words, assets may be converted value-to-value. Any user's electronic wallet 110 may validate any cryptographic transaction, and the miners provide oracle data. Any asset associated with the network 28 of pegged tokens may be converted to any other asset at the market price as determined by the miners.

The cryptographic transactions are decentralized. There is no organization. There is no one running the system. No centralized party. There was no ICO or any sort of issuing of tokens before the protocol went live or set aside. There is no percentage that goes to somebody. There is no airdrop. In other words, the network 28 of pegged tokens does not hijack an existing blockchain and issue tokens to people. In fact, there are no centralized issuers. All assets in the network 28 of pegged tokens are created through asset conversion. Any cryptographic coinage may be converted to USDollar(s), to gold, and/or to another asset. Mining issues the pegged tokens 34, yet mining may be separated by its anti-censorship protocol. The user, and/or the network 28 of pegged tokens, may receive a commit from the protocol before it reveals what it wants to write. It's only the electronic wallets and the miners who read that data to understand how to drive the network 28 of pegged tokens. The execution may thus be entirely in the user's code and in the miner's code.

Each miner may submit one or more Oracle price records. The cryptocurrency gateway server 20 and/or the network 28 of pegged tokens may obtain, receive, retrieve, and/or query for some number of the miners (e.g., 50) with the most proof of work. The cryptocurrency gateway server 20 and/or the network 28 of pegged tokens may then determine an agreement or consensus between the miners. Some or all of the miners may then be compensated (perhaps by one of the assets). The consensus Oracle price record may then be used to select the prices in that block. The cryptocurrency gateway server 20 and/or the network 28 of pegged tokens may thus use crowdsourcing for pricing information

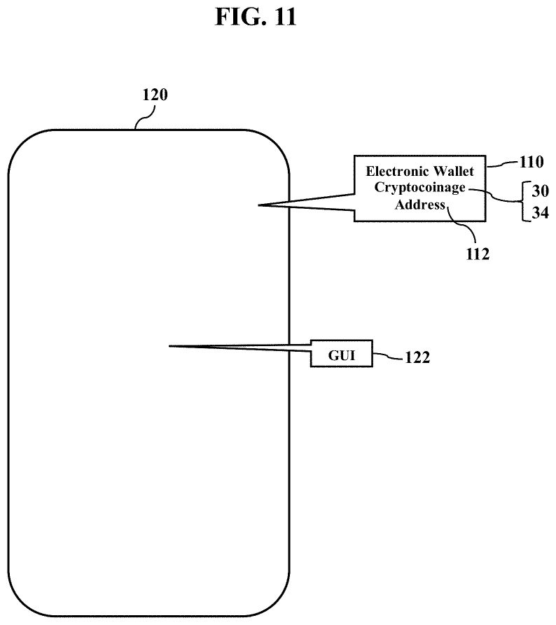

FIGS. 11-13 are simple illustrations of asset conversion, according to exemplary embodiments. Here the user may use any processor-controlled device to convert her/his assets that are linked to the user's electronic wallet 110. The electronic wallet 110 may thus allow the user to buy/sell/trade/exchange any of her cryptographic asset holdings. While the user may use any computer, laptop, kiosk, or other processor-controlled device, most readers are familiar with mobile computing. FIG. 11 thus shows the user's mobile smartphone 120 that may be used to conduct asset transfers/conversions. The user's electronic wallet 110 may be a software application that is stored and executed by the user's smartphone 120. The user, and/or her electronic wallet 110 and smartphone 120, in other words, may be a market participant in the market exchange for the cryptographic assets. The electronic wallet 110 and/or the smartphone 120 is/are registered and/or authorized to submit transactions/orders. As the reader likely understands, the smartphone 120 has a hardware processor that executes the electronic wallet 110 stored in a memory device. The electronic wallet 110 may be associated with, or configured with, the single account address 112. The account address 112 may thus be associated with, or related to, values or holdings in each one of the multiple cryptographic tokens 30 and 34. The electronic wallet 110, however, may be associated with, or configured with, multiple account addresses 112, with each account address associated with a different one of the user's cryptographic asset holdings. The electronic wallet 110 may cause the smartphone 120 to generate and display a graphical user interface 122. The user may thus make tactile inputs to her smartphone 120 (such as via a capacitive or other touch-sensitive display) to request asset transfers/conversions.

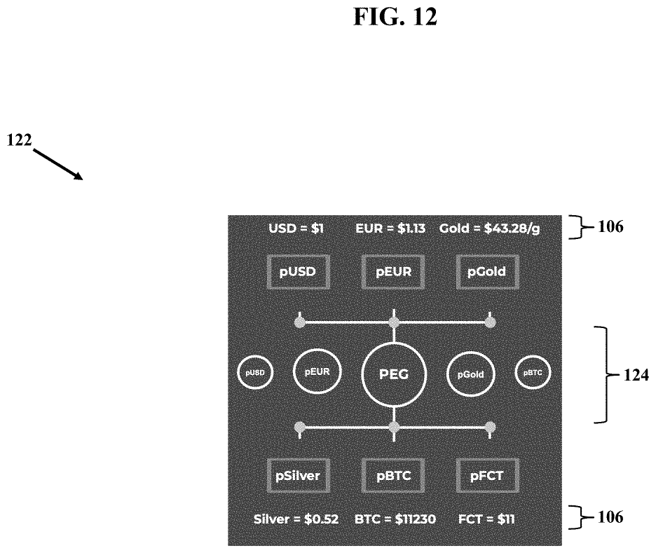

FIG. 12 further illustrates the graphical user interface 122. The graphical user interface 122 illustrates or indicates the user's different cryptographic asset holdings. While any graphical elements may be used, FIG. 12 illustrates simple circular icons 124 that designate different cryptographic asset holdings. One of the icons, for example, indicates the user's assets in cryptographic coinage that is pegged to USDollars (pUSD). Another icon 124 indicates the user's assets in cryptographic coinage that is pegged to Euros (pEUR), another icon 124 indicates the user's assets in the cryptographic pegged tokens (PEG), still another icon 124 indicates the user's assets in cryptographic coinage that is pegged to gold (pGold), and yet another icon 124 indicates the user's assets in cryptographic coinage that is pegged to the BITCOIN® (pBTC). Although not illustrated, other icons may represent assets holdings in any pegged fiat currency and/or any individual or combination of pegged commodities. The user's electronic wallet 110, in other words, may be associated with transactional data or information related to a basket of many different types and values of cryptographic assets. The graphical user interface 122 may also retrieve and display current market values 106 for any cryptographic tokens. If the user wishes to buy/sell/trade/exchange any asset holding, suppose that the user need only graphically touch and move its corresponding icon 124. For example, a graphical movement of the icon 124 (representing the user's assets pegged to gold) to the icon 124 (representing the user's assets in the cryptographic pegged tokens) is interpreted as an input or command to convert at the current market prices/values 106 and exchange rate 102. Indeed, other buy/sell/trade/exchange transactions may be similarly executed between any assets. Any asset may be converted by destroying the original asset and by creating a new instance of another asset class with equal value. Any of the user's assets in the cryptographic pegged tokens may be converted to any other pegged cryptographic asset. Indeed, any asset may occupy or be middle traded from one to another asset based on values provided by the oracles. The user is thus always able to convert one asset or “thing” to another/different asset of “thing” at the market prices/values 106 and exchange rate 102. Exemplary embodiments thus create opportunities for arbitrage.

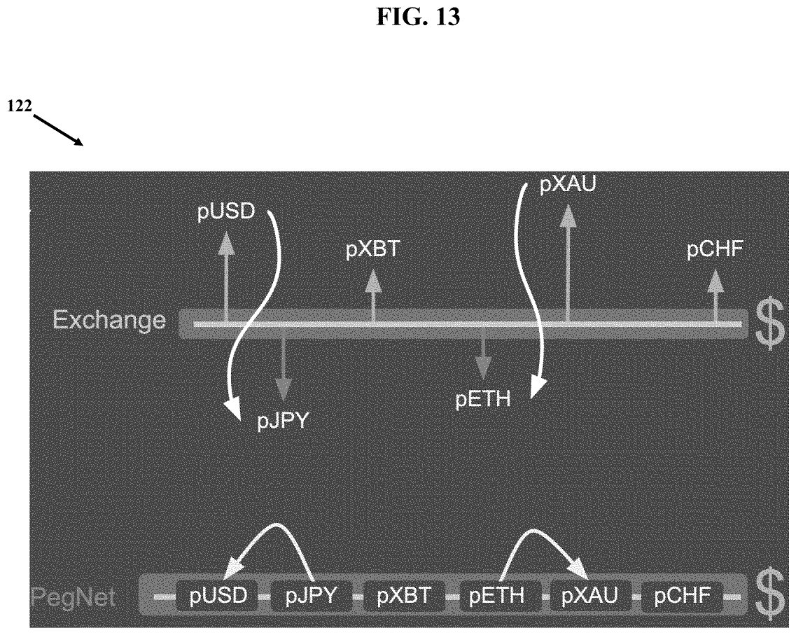

FIG. 13 also illustrates examples of arbitrage. Suppose one of the assets is above its referenced price (such as by the exchange where pUSD is 5% high), and also suppose the Yen (pJPY) is low (perhaps down 2%). The difference is thus 7%. If the user sells her high-priced asset pUSD and buys the low-priced asset pJPY, the pegged token 34 may be converted at market price 106. The low-cost asset, in other words, may be converted to the high-priced asset at market price 106. The user will gain that 7% selling on the exchange, which has an immediate effect of depressing the price of her asset. Buying on the exchange has the immediate effect of bringing that asset price up, but the long-term stabilization effect also occurs because when the user converts her pYen to pUSD. The user is destroying the pYen (she previously held) to create more of the asset that she is targeting. The system naturally increases the supply of the asset in high demand and decreases the supply of the asset in low demand.

FIG. 13 also illustrates conversion of Yuan and Ethereum. If pXAU is high, the user may sell pXAU, buy the low-priced asset pETH, and she can lower the supply of either by converting it to pYuan stabilizing it long-term and short-term. Exemplary embodiments accomplish these trades and market stabilizations without a smart contract and without any obligation of any party. Users are simply motivated to make a profit.

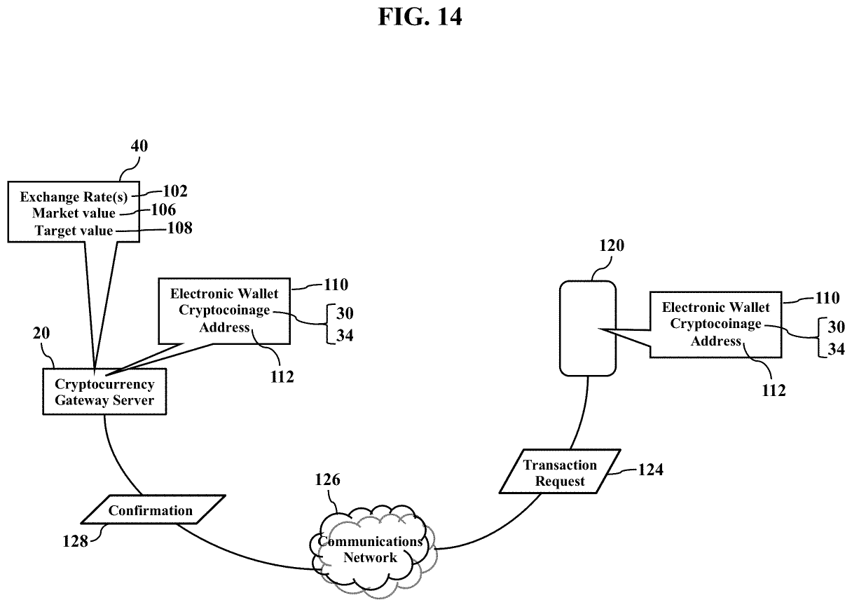

FIG. 14 illustrates a transactional process for asset conversions, according to exemplary embodiments. Here the user may interface with the cryptocurrency gateway server 20 to buy/sell/trade/exchange her cryptographic holdings. Again, because most readers are familiar with mobile computing, FIG. 14 illustrates the user's mobile smartphone 120 interfacing with the cryptocurrency gateway server 20 to conduct asset transfers/conversions. The user's basket or collection of assets are linked to her electronic wallet 110 (whether stored/retrieved from the user's smartphone 120 or the cryptocurrency gateway server 20). The user's smartphone 120 sends a transaction request 124 via a communications network 126 to the network address associated with the cryptocurrency gateway server 20. The transaction request 124 contains or specifies data and information describing a buy/sell order or transaction. The transaction request 124 is thus associated with a first cryptographic asset to be sold and a second cryptographic asset to be purchased. When the cryptocurrency gateway server 20 receives the transaction request 124, the cryptocurrency gateway server 20 executes the conversion application 40 that causes the cryptocurrency gateway server 20 to execute the cryptocurrency transaction according to the market values or prices 106 and cryptographic exchange rates 102. The cryptocurrency gateway server 20 may then send a transaction confirmation 128 via the communications network 126 to the network address associated with the user's smartphone 120. While the transaction confirmation 128 may be any message, data, or information, most readers are likely familiar with a webpage. The cryptocurrency gateway server 20 sends the webpage to the user's smartphone 120, and the smartphone 120 calls a web browser to process the webpage for display. The transaction confirmation 128 thus confirms that the cryptographic transaction was executed. The user's electronic wallet 110 is updated to reflect the transaction.

Creation and destruction may thus be performed. Because the values of the cryptographic tokens 30 and 34 may be constant, in variable, and/or variable (depending on the underlying asset), if any), their corresponding values may be related (perhaps via the cryptographic exchange rate 102). Their individual market supplies may be thus managed using the creation operation 50 and/or the destruction operation 60. The user may thus convert a certain number of her variable-priced cryptographic tokens 30 to any of the pegged cryptographic token(s) 34, perhaps on demand, at the current cryptographic exchange rate 102. The cryptocurrency gateway server 20 may perform the destruction operation 60 to destroy the user's requested number of her variable-priced cryptographic token(s) 30 and also perform the creation operation 50 to create an equivalent number of the pegged cryptographic tokens 34, as determined by the current cryptographic exchange rate 102. In plain words, exemplary embodiments destroy the user's requested number of her variable-priced cryptographic tokens 30 and create the equivalent number of the pegged cryptographic tokens 34. The user may also convert a certain number of her pegged cryptographic tokens 34 to the equivalent number of the variable-priced cryptographic tokens 30, perhaps on demand, again at the current cryptographic exchange rate 102. The cryptocurrency gateway server 20 may thus perform the destruction operation 60 to destroy the user's requested number of her pegged cryptographic tokens 34 and also perform the creation operation 50 to create the equivalent number of the variable-priced cryptographic tokens, as determined by the current cryptographic exchange rate 102.

Oracles may publish the current cryptographic exchange rate 102 and/or the market values 106. The cryptographic exchange rates 102, the market values 106, and/or the target values 108 need to be discovered and dispersed to the users. Users, blockchain miners, and/or other federated servers may find it inefficient to continuously and/or repeatedly query some entity (such as the cryptocurrency gateway server 20) for current pricing. Moreover, these pricing queries would contribute to packet congestion in the communications network 126. Pricing stability may require a faster and simpler mechanism for pricing discovery. Exemplary embodiments, then, may utilize any query mechanism to discover the current cryptographic exchange rates 102, the market values 106, and/or the target values 108. One or more oracle servers, for example, may communicate with the cryptocurrency gateway server 20, the network 22 of cryptographic tokens, the network 28 of pegged tokens, and/or the user's smartphone 120. The oracle servers perform an oracle function that provides historical and/or the current cryptographic exchange rates 102, the market values 106, and/or the target values 108. Any device or network element may send a query to the oracle server and retrieve cryptographic exchange rates 102, the market values 106, and/or the target values 108. Any of the blockchains 48, 72, 74, and/or 86 may additionally or alternatively publish pricing information as a transaction in a block of data for recordation and historical analysis.

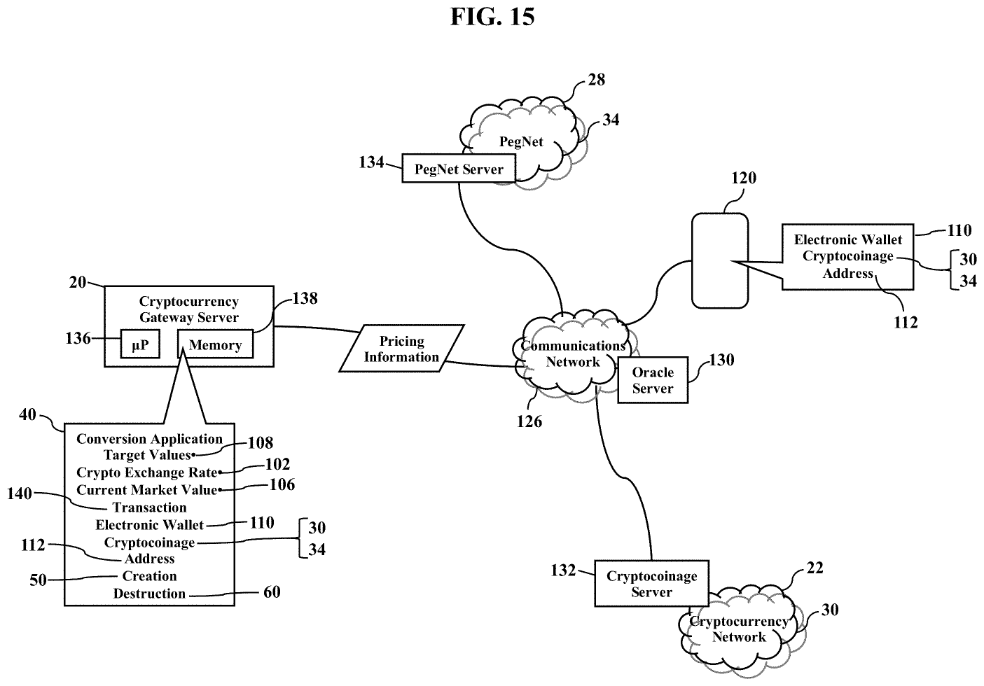

FIGS. 15-17 are more detailed illustrations of an operating environment, according to exemplary embodiments. FIG. 15 illustrates the cryptocurrency gateway server 20 communicating via the communications network 126 with an oracle server 130, with a cryptocoinage server 132 operating in the cryptocurrency network 22, and with a PegNet server 134 operating in the network 28 of pegged tokens (or “PegNet”). The cryptocurrency gateway server 20 has a processor 136 (e.g., “μP”), application specific integrated circuit (ASIC), or other component that executes the conversion application 40 stored in a local, solid-state memory device 138. The cryptocurrency gateway server 20 has a network interface (not shown for simplicity) to the communications network 126, thus allowing two-way, bidirectional communication. The conversion application 40 includes instructions, code, and/or programs that cause the cryptocurrency gateway server 20 to perform operations, such as receiving pricing information from the oracle server 130. The pricing information may include the cryptographic exchange rates 102, the market values 106, and/or the target values 108. The oracle server 130 may feed the pricing information on a periodic or random timing basis. However, the cryptocurrency gateway server 20 may send queries via the communications network 126 to the network or IP address associated with the oracle server 130, and the queries specify a query parameter that requests the latest and/or historical pricing information. The oracle server 130 may then retrieve and send the pricing information as a query response.

The cryptocurrency gateway server 20 performs cryptographic currency/coinage conversions. When any cryptocurrency token 30 is transferred, traded, converted, and/or exchanged between the cryptocurrency network 22 and the network 28 of pegged tokens, the cryptocoinage server 132 sends a cryptographic coinage transaction 140 to the cryptocurrency gateway server 20. Similarly, should any pegged token (or “PEG”) 34 be transferred, traded, converted, and/or exchanged between the network 28 of pegged tokens and the cryptocurrency network 22, the cryptographic coinage transaction 140 is sent to the cryptocurrency gateway server 20. The cryptocurrency gateway server 20 may thus intercept, manage, and even conduct any or all cryptographic coinage transactions 140 between different cryptographic assets. The cryptocurrency gateway server 20 may thus function as a middleware and/or network element that brokers cryptographic transactions between the cryptocurrency systems/networks.

The cryptocoinage server 132 and the PegNet server 134 are also processor-controlled. The cryptocoinage server 132 is operated by, or on behalf of, the cryptocurrency network 22, while the PegNet server 134 is operated by, or on behalf of, the network 28 of pegged tokens. Each of the cryptocoinage server 132 and the PegNet server 134 has a processor (e.g., “pP”), application specific integrated circuit (ASIC), or other component (not shown for simplicity) that executes a client-side conversion application (not shown for simplicity) stored in a local, solid-state memory device (not shown for simplicity). Each of the cryptocoinage server 132 and the PegNet server 134 has a network interface (not shown for simplicity) to the communications network 126, thus allowing two-way, bidirectional communication. The client-side conversion application includes instructions, code, and/or programs that cause the cryptocoinage server 132 and the PegNet server 134 to perform operations, such as sending the cryptographic coinage transaction 140 to the cryptocurrency gateway server 20. The cryptocurrency gateway server 20, the cryptocoinage server 132, and the PegNet server 134 may thus cooperate to convert any cryptographic coinage asset into a different cryptographic coinage asset. Similarly, the conversion application 40 and the client-side conversion application(s) cooperate to convert any cryptographic coinage asset into a different cryptographic coinage asset.

The cryptocurrency gateway server 20 may receive an electronic order that specifies any cryptographic transaction (such as a buy transaction and/or a sell transaction). While the electronic order 100 may be sent from any entity, FIG. 15 illustrates the user's smartphone 120 as a market participant. That is, the user's smartphone 120 is a member of a market exchange and is registered and/or authorized to submit the electronic order specifying a buy or sell of a quantity or number of the pegged cryptographic token 34 and/or the variable-priced cryptographic token 30. The cryptocurrency gateway server 20 obtains, reads, or retrieves the pricing information and processes and/or executes the electronic order. That is, the cryptocurrency gateway server 20 processes and/or executes the creation operation 50 and/or the destruction operation 60 according to the cryptographic exchange rate 102.

Cryptographic conversion may occur. For example, the user's smartphone 120 may request that the cryptocurrency gateway server 20 coordinate a conversion of a certain number of the variable-priced cryptographic token(s) 30 to the pegged cryptographic token(s) 28 at the current cryptographic exchange rate 102. As another example, the user's smartphone 120 may request that the cryptocurrency gateway server 20 convert a requested number of the pegged cryptographic token(s) 28 into the variable-priced cryptographic token(s) 30 at the current cryptographic exchange rate 102. The cryptocurrency gateway server 20 may thus create or destroy the variable-priced cryptographic token(s) 30 and/or the pegged cryptographic token(s) 28, according to the creation operation 50 and/or the destruction operation 60.

Near real time supply management may be performed. Whenever the cryptocurrency gateway server 20 receives the electronic order (specifying the buy transaction and/or the sell transaction), the cryptocurrency gateway server 20 may notify the cryptocoinage server 132 and/or the PegNet server 134. The cryptocurrency gateway server 20, for example, may send an order notification to the network or Internet Protocol address associated with the cryptocoinage server 132 and/or the PegNet server 134. The order notification may include or specify the quantity or number of the pegged cryptographic token 34 and/or the variable-priced cryptographic token 30 to be bought or sold. The order notification may include or specify the pricing information at which the pegged cryptographic token 34 and/or the variable-priced cryptographic token 30 is bought or sold. The cryptocurrency gateway server 20 may deposit or withdraw one or more pegged cryptographic token 34 to/from the market exchange to stabilize its current market value 106 to its target value 108. Likewise, the cryptocurrency gateway server 20 may deposit or withdraw one or more variable-priced cryptographic tokens 30 to/from the market exchange to stabilize its current market value 106 to its target value 108.

Exemplary embodiments may be applied regardless of networking environment. Exemplary embodiments may be easily adapted to stationary or mobile devices having cellular, wireless local area networking capability (such as WI-Fi®), near field, and/or BLUETOOTH® capability. Exemplary embodiments may be applied to mobile devices utilizing any portion of the electromagnetic spectrum and any signaling standard (such as the radio spectrum and IEEE 802 family of standards, GSM/CDMA/TDMA or any cellular standard, and/or the ISM band). Exemplary embodiments, however, may be applied to any processor-controlled device operating in the radio-frequency domain and/or the Internet Protocol (IP) domain. Exemplary embodiments may be applied to any processor-controlled device utilizing a distributed computing network, such as the Internet (sometimes alternatively known as the “World Wide Web”), an intranet, a local-area network (LAN), and/or a wide-area network (WAN). Exemplary embodiments may be applied to any processor-controlled device utilizing power line technologies, in which signals are communicated via electrical wiring. Indeed, exemplary embodiments may be applied regardless of physical componentry, physical configuration, or communications standard(s).

Exemplary embodiments may utilize any processing component, configuration, or system. Any processor could be multiple processors, which could include distributed processors or parallel processors in a single machine or multiple machines. The processor can be used in supporting a virtual processing environment. The processor could include a state machine, application specific integrated circuit (ASIC), programmable gate array (PGA) including a Field PGA, or state machine. When any of the processors execute instructions to perform “operations,” this could include the processor performing the operations directly and/or facilitating, directing, or cooperating with another device or component to perform the operations.

Exemplary embodiments may packetize. When any device or server communicates via the communications network 126, the device or server may collect, send, and retrieve information. The information may be formatted or generated as packets of data according to a packet protocol (such as the Internet Protocol). The packets of data contain bits or bytes of data describing the contents, or payload, of a message. A header of each packet of data may contain routing information identifying an origination address and/or a destination address.

Profit motives and market forces likely prevail. As this disclosure above explained, if one cryptographic token 34 is trading low, then traders/holders in the market exchange may consider the pegged cryptographic token 34 to be devalued relative to a different cryptographic token 30. The cryptocurrency gateway server 20 may manage a pool of the pegged cryptographic tokens 34 and other pools of different variable-priced cryptographic tokens 30. When the pegged cryptographic token 34 is devalued by the market exchange, the demand is low and traders/holders will have a profit incentive to convert a high-priced cryptographic token 30 (according to the cryptographic exchange rate 102). Because the cryptocurrency gateway server 20 may monitor the total number of the variable-priced cryptographic tokens 30, the cryptocurrency gateway server 20 may also, nearly simultaneously, buy an excess number of the variable-priced cryptographic tokens 30 to maintain a consistent supply or pool of the variable-priced cryptographic tokens 30. Recall that a buy order destroys some variable-priced cryptographic token 30 and creates or gains a different cryptographic token 30 and/or the pegged cryptographic tokens 34. Simply put, anytime a trader/holder/user can make money, market forces will push up the market value 106. An increasing market price concomitantly increases the demand, thus bringing the current market value 106 toward the target value 108.

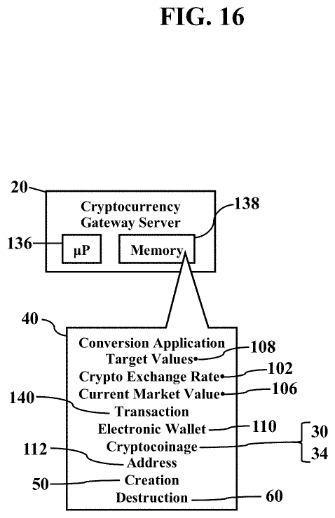

FIG. 16 illustrates algorithmic conversion. When a buy/sell/trade/exchange opportunity exists, the user (via her smartphone 120) and/or the cryptocurrency gateway server 20 may initiate a cryptographic conversion between different cryptographic coinages. Because the values of the cryptographic tokens 30 and 34 may be constant, in variable, and/or variable (depending on the underlying asset), if any), their corresponding values may be related (perhaps via the cryptographic exchange rate 102). Their individual market supplies may be thus managed using the creation operation 50 and/or the destruction operation 60. The cryptocurrency gateway server 20 may implement pre-programmed fiscal/monetary measures to maintain the total population of pool of the cryptographic tokens 30 and 34 and thus their respective current market values 106. For example, the conversion application 40 may identify and execute a logical rule that forces a destruction or withdrawal of a quantity of one cryptographic token 30 and a creation of injection of an equivalent quantity of a different cryptographic token 30. The logical rule may thus be an algorithmic code or instruction that is executed in response to buy/sell orders/transactions according to the cryptographic exchange rates 102, the market values 106, and/or the target values 108. The cryptocurrency gateway server 20 may thus withdraw and destroy a desired quantity of one cryptographic coinage asset and create or inject an equivalent quantity of a different cryptographic coinage asset. In plain words, exemplary embodiments destroy the user's requested number of her desired quantity of one cryptographic coinage asset and create the equivalent number of the different cryptographic coinage asset. The user may also convert a certain number of her pegged cryptographic tokens 34 to the equivalent number of the variable-priced cryptographic tokens 30, perhaps on demand, again at the current cryptographic exchange rate 102. The cryptocurrency gateway server 20 may thus perform the destruction operation 60 to destroy the user's requested number of her pegged cryptographic tokens 34 and also perform the creation operation 50 to create the equivalent number of the variable-priced cryptographic tokens, as determined by the current cryptographic exchange rate 102.

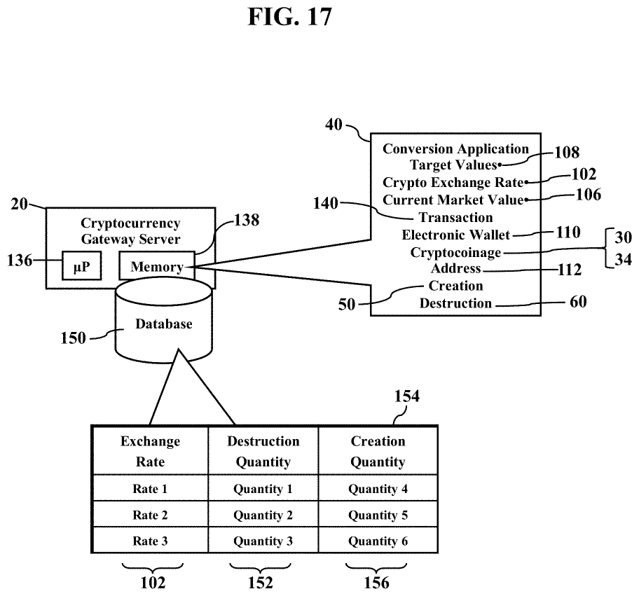

As FIG. 17 illustrates, exemplary embodiments may query an electronic database 150. The electronic database 150 is illustrated as being locally stored and maintained by the cryptocurrency gateway server 20, but any of the database entries may be stored at any remote, accessible location via the communication network 126 (illustrated by FIG. 15). Regardless, the electronic database 150 relates, maps, or associates different value differences of the exchange rate 102 to their corresponding destruction quantity 152. While the electronic database 150 may have any logical and physical structure, a relational structure is thought perhaps easiest to understand. FIG. 17 thus illustrates the electronic database 150 as a table 154 that relates, maps, or associates each exchange rate 102 to its corresponding destruction quantity 152. So, once the cryptographic exchange rates 102, the market values 106, and/or the target values 108 is/are determined, exemplary embodiments may query the electronic database 150 to identify its corresponding destruction quantity 152. While FIG. 17 only illustrates a simple example of a few entries, in practice the electronic database 150 may have many entries that detail a rich depository of entries and their finely defined destruction quantities 126. Once the destruction quantity 152 is determined, exemplary embodiments perform the destruction operation 60 to remove or delete the destruction quantity 152 of the cryptographic tokens 30/34.

The creation operation 50 may also be performed. Recall that exemplary embodiments may also monitor the total population, quantity, or pool of the cryptographic tokens 28 and/or 30 in the market exchange. Once the cryptographic exchange rates 102, the market values 106, and/or the target values 108 is/are determined, the same or a different rule may also be implemented to create and to inject additional cryptographic tokens 28 and/or 30 into the market exchange. That is, the electronic database 150 may additionally or alternatively have entries that associate the different exchange rates 102 to different creation quantities 156. Exemplary embodiments may thus query the electronic database 150 to identify its corresponding creation quantity 156. Once the creation quantity 156 is determined, exemplary embodiments perform the creation operation 50 to deposit or inject newly-created cryptographic tokens 28 and/or 30. Exemplary embodiments may implement these pre-programmed fiscal/monetary measures to stabilize the current market value 106 of the cryptographic tokens 28 and/or 30.

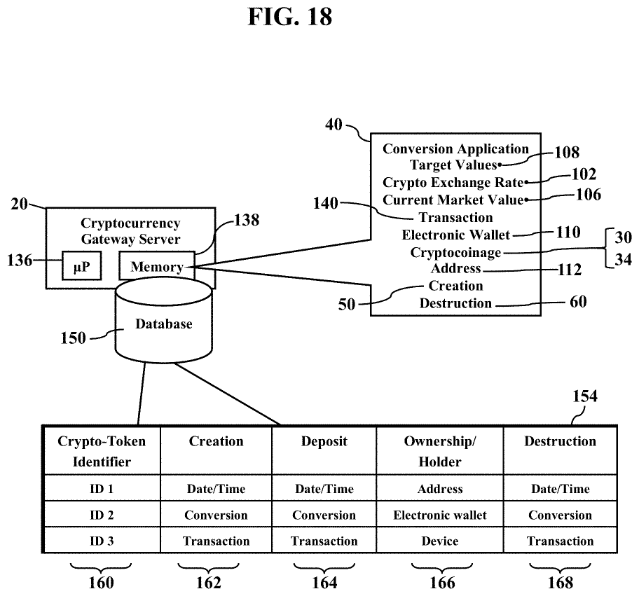

FIG. 18 illustrates indexing of cryptographic coinage, according to exemplary embodiments. When any cryptographic token 30 and/or 34 is created or destroyed (perhaps initially or via the creation operation 50 and/or the destruction operation 60, as above explained), here exemplary embodiments may then log the details. As a simple example, suppose the cryptocurrency gateway server 20 logs each creation operation 50 and each destruction operation 60 in the electronic database 150. The electronic database 150 may thus store and maintain detailed transactional records for each cryptographic token 30 and/or 34. Suppose, for example, that each cryptographic token 30 and/or 34 is uniquely identified with a unique token identifier 160. Moreover, the electronic database 150 has entries that relate, associate, or map each token identifier 160, its creation details 162, its deposit details 164 of entry or injection into the market exchange, and its ownership details 166 (such as buyer/seller account addresses 112, holder information, and/or electronic wallet 110 details). Moreover, if the cryptographic token 30 and/or 34 was subject to the destruction operation 60, then the electronic database 150 may log its corresponding destruction details 168 documenting its withdrawal from the market exchange. Although not shown, the entries may further relate each cryptographic token 30 and/or 34 to its corresponding pricing information (e.g., cryptographic exchange rates 102, the market values 106, and/or the target values 108). Exemplary embodiments may thus generate a central repository that indexes each cryptographic token 30 and/or 34 that is created and/or deposited into the market exchange. The entries may further relate each cryptographic token 30 and/or 34 that was destroyed after creation (according to the creation operation 50). The entries may thus fully document what tokens 30 and/or 34 were created, how and when and why, and also their destruction, if any.

The electronic database 150 may be queried for its entries. Because the electronic database 150 may store detailed creation and destruction records for each cryptographic token 30 and/or 34, any client may send a query to the cryptocurrency gateway server 20 to identify related entries. As an example, a query parameter may specify the unique token identifier 160 and request its corresponding entries (such as its date/time of creation and current ownership/holder details). A query response is sent back to the client (such as the user's smartphone 120), and the query response specifies any of the corresponding database entries.

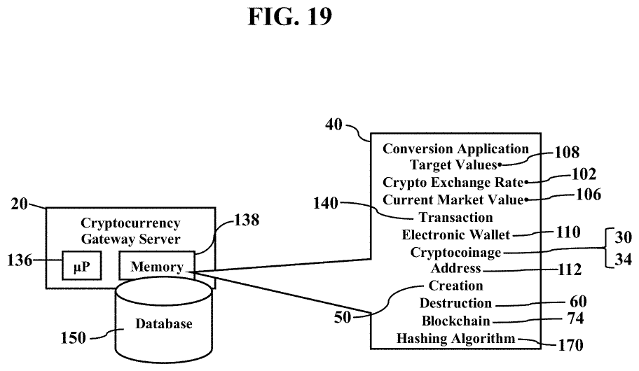

FIG. 19 illustrates blockchain recordations, according to exemplary embodiments. Here, when any cryptographic token 30 and/or 34 is created or destroyed, exemplary embodiments may record that creation operation 50 and/or destruction operation 60 to the blockchain 74. The cryptocurrency gateway server 20, for example, may generate the block of data within the blockchain 74. The conversion application 40 may even call, invoke, and/or apply an electronic representation of a hashing algorithm 170 to any of the entries in the electronic database 150 and/or to the block of data within the blockchain 74. The hashing algorithm 170 thus generates one or more hash values, which may be incorporated into the blockchain 74. The conversion application 40 may then instruct the cryptocurrency gateway server 20 to send the blockchain 74 to any destination, such as the network address (e.g., Internet protocol address) associated with the cryptographic server 132 and/or the PegNet server 134 (illustrated in FIG. 15).

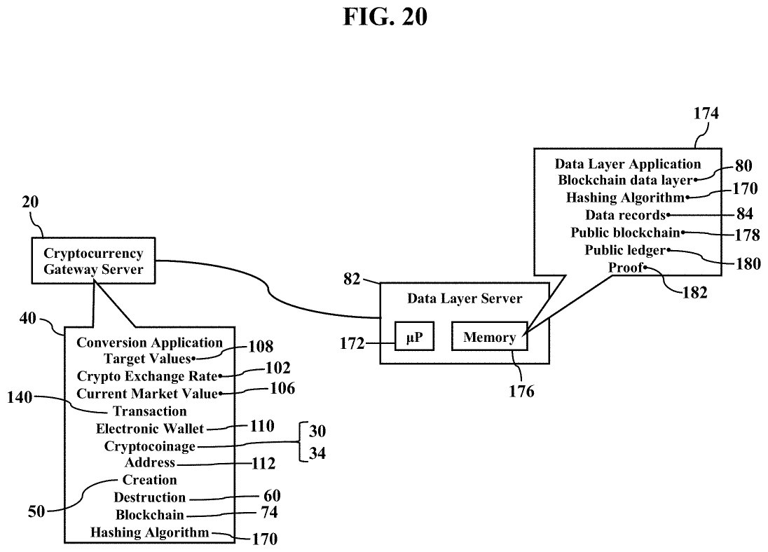

FIGS. 20-22 illustrate the blockchain data layer 80, according to exemplary embodiments. The cryptocurrency gateway server 20 may interface with, and/or cooperate with, the data layer server 82 that generates the blockchain data layer 80. Even though the cryptocurrency gateway server 20 may record the creation operation 50 and the destruction operation 60 to the blockchain 74 (as FIG. 19 illustrated), the cryptocurrency gateway server 20 may additionally, or alternatively, document the creation operation 50 and the destruction operation 60 to the blockchain data layer 80. When any cryptographic token 30 and/or 34 is created or destroyed, the corresponding creation operation 50 and the destruction operation 60 may be documented within the blockchain data layer 80. The data layer server 82 generates the blockchain data layer 80. The data layer server 82 has a processor 172 (e.g., “μP”), application specific integrated circuit (ASIC), or other component that executes a data layer application 174 stored in a local, solid-state memory device 176. The data layer server 82 has a network interface to the communications network 126 (illustrated in FIG. 15). The data layer application 174 includes instructions, code, and/or programs that cause the data layer server 82 to perform operations, such as receiving a packetized message, transmission, data, and/or information describing or associated with the creation operation 50 and/or the destruction operation 60. The data layer application 174 then causes the data layer server 82 to generate the blockchain data layer 80. The data layer application 174 may optionally call, invoke, and/or apply the hashing algorithm 170 to the data records 84 contained within the blockchain data layer 80. The data layer application 174 may also generate a public blockchain 178. The data layer application 174 may thus generate a public ledger 180 that publishes, records, or documents the creation operation 50 and/or the destruction operation 60. The data layer application 174 may document any cryptographic transaction, and the data layer application 174 may optionally apply the hashing algorithm 170 to the data records 84 to generate a cryptographic proof 182 of the cryptographic transaction.

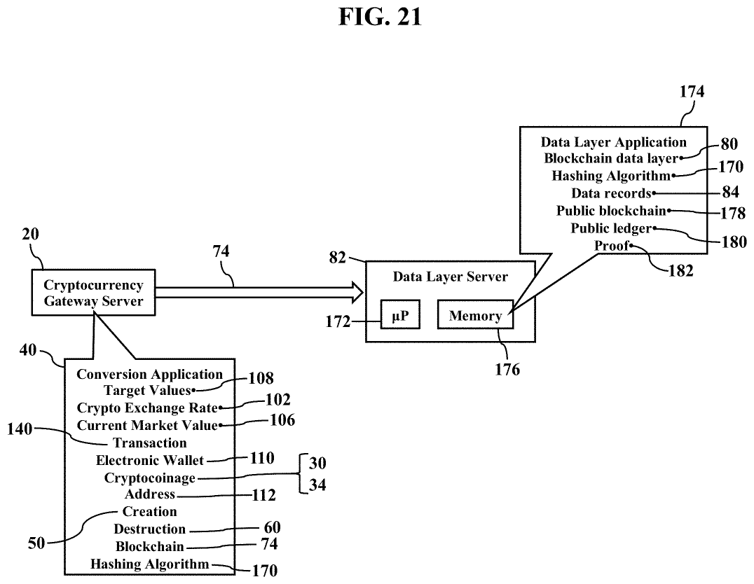

FIG. 21 also illustrates the blockchain data layer 80. When the cryptocurrency gateway server 20 records the creation operation 50 and the destruction operation 60 to the blockchain 74, the cryptocurrency gateway server 20 may send, route, or distribute the blockchain 74 to the network address (e.g., IP address) associated with the data layer server 82. So, even if the blockchain 74 is generated by a public or private entity, the data layer server 82 may thus be an authorized federated recipient of the blockchain 74. The data layer application 174 then causes the data layer server 82 to generate the blockchain data layer 80, based on the data contained within the blocks of data within the blockchain 74. The data layer application 174 and/or the data layer server 82 generate the data records 84 in the blockchain data layer 80. Moreover, the data layer application 174 may also generate the public blockchain 178 as the public ledger 180 that publishes, records, or documents the creation operation 50 and/or the destruction operation 60. The data layer application 174 may document any cryptographic transaction, and the data layer application 174 may optionally apply the hashing algorithm 170 to the data records 84 to generate the cryptographic proof 182 of the cryptographic transaction. The public blockchain 178 thus publishes the cryptographic proof 182 as a public ledger that establishes chains of blocks of immutable evidence.

The blockchain data layer 80 may be searched. Because blockchain data layer 80 may track and/or prove any creation operation 50 and/or any destruction operation 60, exemplary embodiments may search the blockchain data layer 80 for any query parameter. For example, the data layer server 82 may receive queries from clients requesting the data records 84 within the blockchain data layer 80 that match a query parameter. As a simple example, suppose a query specifies a token identifier as a query parameter. The token identifier uniquely identifies its corresponding cryptographic token 30 and/or 34. The data layer server 82 may then act as a query handler, determine a matching data record 84 or other entry in the blockchain data layer 80, and identify/retrieve its corresponding contents or data or entries. As another example, suppose a query specifies some parameter or party associated with any cryptographic transaction or conversion (such as a user/party/holder/wallet identifier). The data layer server 82 may then identify/retrieve any data records 84 associated with any unique identifier.

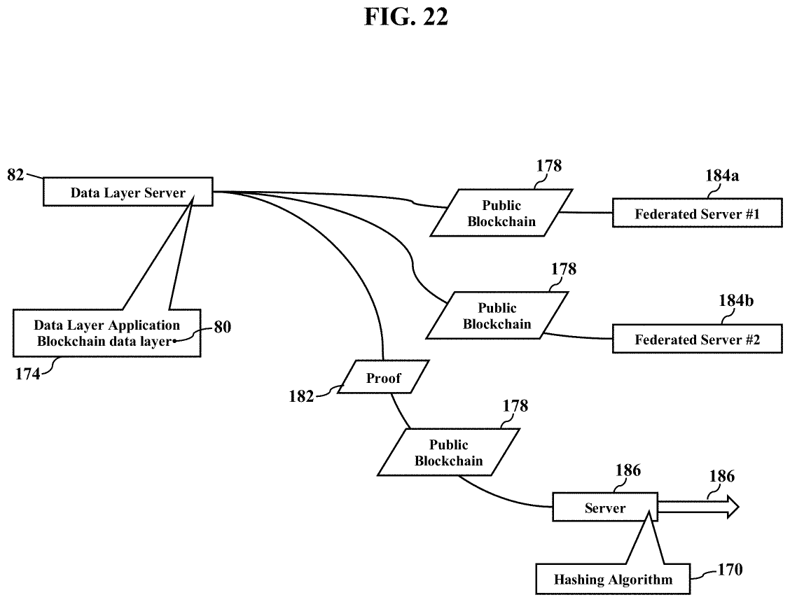

FIG. 22 illustrates additional publication mechanisms. Once the blockchain data layer 80 is generated, the blockchain data layer 80 may be published in a decentralized manner to any destination. The data layer server 82, for example, may generate and distribute the public blockchain 178 (via the communications network 126 illustrated in FIG. 15) to one or more federated servers 184. While there may be many federated servers 184, for simplicity FIG. 22 only illustrates two (2) federated servers 184a and 184b. The federated server 184a and 184b provide a service and, in return, they are compensated according to a compensation or services agreement or scheme.

Exemplary embodiments include still more publication mechanisms. For example, the cryptographic proof 182 and/or the public blockchain 178 may be sent (via the communications network 126 illustrated in FIG. 15) to still another server 186. The server 186 may then add another, third layer of cryptographic hashing (perhaps using the hashing algorithm 170) and generate another or second public blockchain 188. While the server 186 and/or the public blockchain 188 may be operated by, or generated for, any entity, exemplary embodiments may integrate another cryptographic coin mechanism. That is, the server 186 and/or the public blockchain 188 may be associated with BITCOIN®, ETHEREUM®, RIPPLE®, or other cryptographic coin mechanism. The cryptographic proof 182 and/or the public blockchains 178 and 186 may be publicly distributed and/or documented as evidentiary validation. The cryptographic proof 182 and/or the public blockchains 178 and 186 may thus be historically and publicly anchored for public inspection and review.

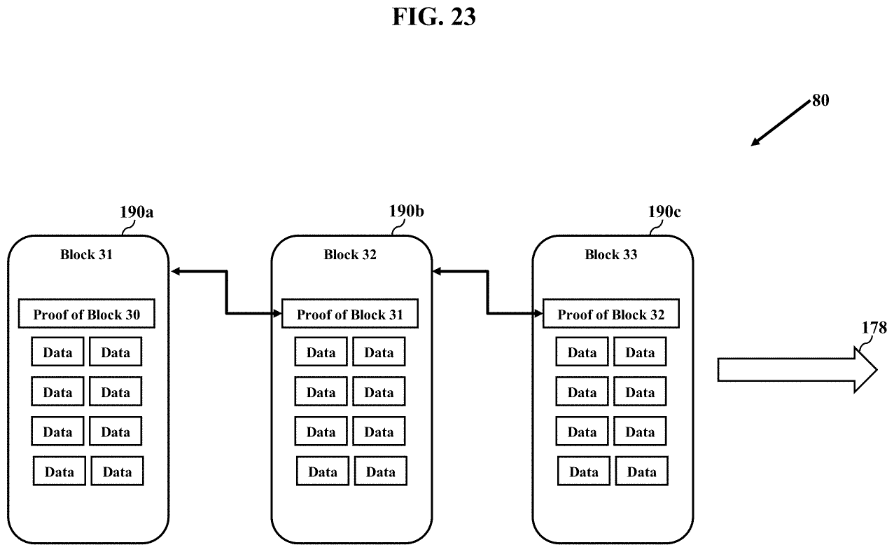

FIGS. 23-27 further illustrate the blockchain data layer 80, according to exemplary embodiments. The blockchain data layer 80 chains hashed directory blocks 190 of data into the public blockchain 178. For example, the blockchain data layer 80 accepts any input data (such as any of the data logged in the electronic database 150, and/or the blockchain 74 sent from the cryptocurrency gateway server 20 illustrated in FIG. 21) within a window of time. While the window of time may be configurable from fractions of seconds to hours, exemplary embodiments use ten (10) minute intervals. FIG. 23 illustrates a simple example of only three (3) directory blocks 190a-c of data, but in practice there may be millions or billions of different blocks. Each directory block 190 of data is linked to the preceding blocks in front and the following or trailing blocks behind. The links are created by hashing all the data within a single directory block 190 and then publishing that hash value within the next directory block.

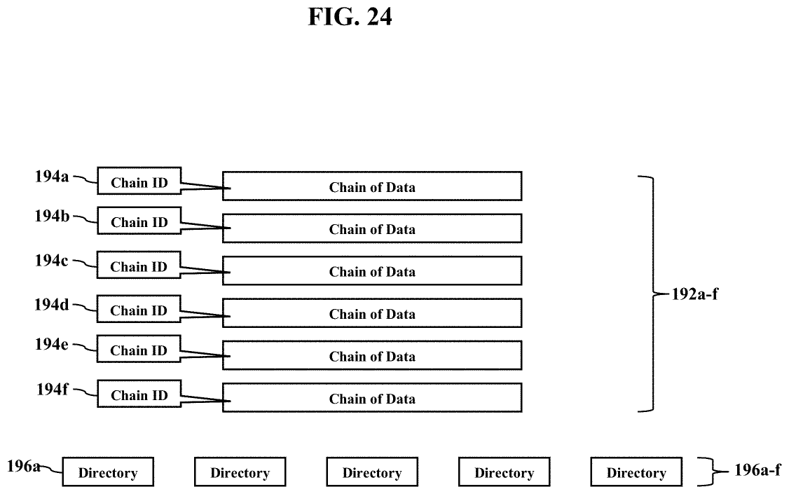

As FIG. 24 illustrates, published data may be organized within chains 192. Each chain 192 is created with an entry that associates a corresponding chain identifier 194. As a simple example, suppose the user has several different cryptographic coinage assets, and each cryptographic coinage asset has its own corresponding chain identifier 194a-d. The blockchain data layer 80 may thus track any buy/sell/conversion and any other data associated with each cryptographic coinage asset with its corresponding chain identifier 194a-d. As other examples, each user and/or or cryptographic transaction may also have its corresponding chain identifier 194. A unique chain 192 may thus be used to track the buy/sell/creation/destruction events for any token 30 and/or 34. New and old data in time may be associated with, linked to, identified by, and/or retrieved using the chain identifier 194a-d. Each chain identifier 194a-d thus functionally resembles a directory 196a-d (e.g., files and folders) for organized data entries.

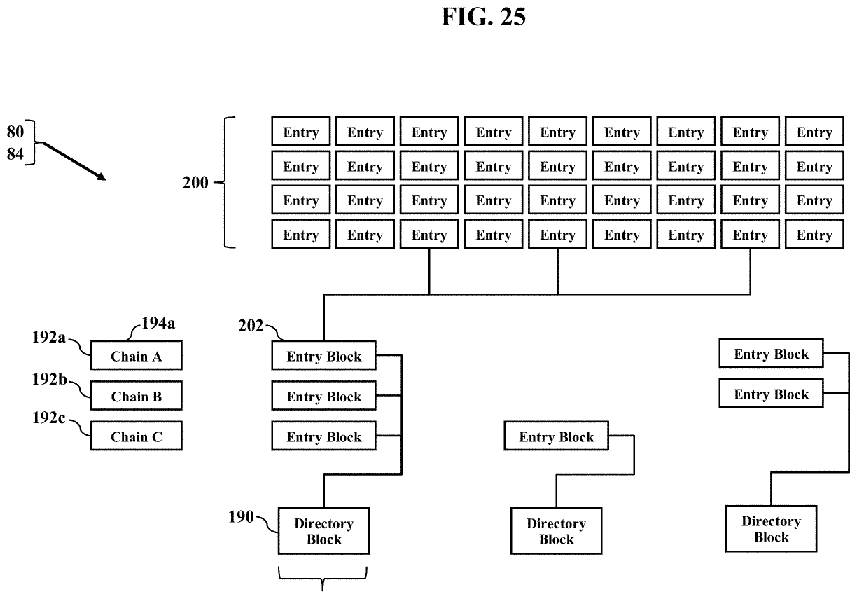

FIG. 25 illustrates the data records 166 in the blockchain data layer 80. As data is received as an input (such as any of the data logged in the electronic database 150, and/or the blockchain 74 sent from the cryptocurrency gateway server 20 illustrated in FIG. 21), data is recorded within the blockchain data layer 80 as an entry 200. While the data may have any size, small chunks (such as 10 KB) may be pieced together to create larger file sizes. One or more of the entries 200 may be arranged into entry blocks 202 representing each chain 192 according to the corresponding chain identifier 194. New entries for each chain 192 are added to their respective entry block 202 (again perhaps according to the corresponding chain identifier 194). After the entries 200 have been made within the proper entry blocks 202, all the entry blocks 202 are then placed within in the directory block 190 generated within or occurring within a window 204 of time. While the window 204 of time may be chosen within any range from seconds to hours, exemplary embodiments may use ten (10) minute intervals. That is, all the entry blocks 202 generated every ten minutes are placed within in the directory block 190.

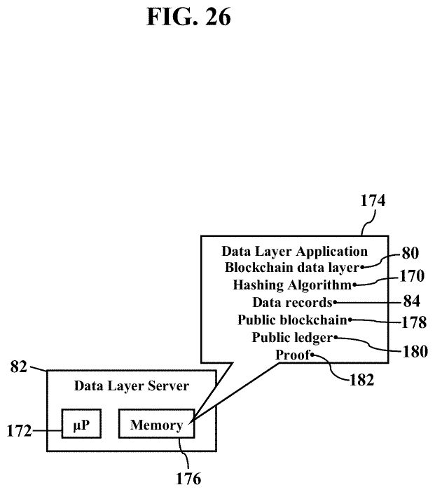

FIG. 26 illustrates cryptographic hashing. The data layer server 82 executes the data layer application 174 to generate the data records 84 in the blockchain data layer 80. The data layer application 174 may then instruct the data layer server 82 to execute the hashing algorithm 170 on the data records 84 (such as the directory block 190 illustrated in FIGS. 23-25). The hashing algorithm 170 thus generates one or more hash values as a result, and the hash values represent the hashed data records 84. As one example, the blockchain data layer 80 may apply a Merkle tree analysis to generate a Merkle root (representing a Merkle proof 182) representing each directory block 190. The blockchain data layer 80 may then publish the Merkle proof 182 (as this disclosure explains).

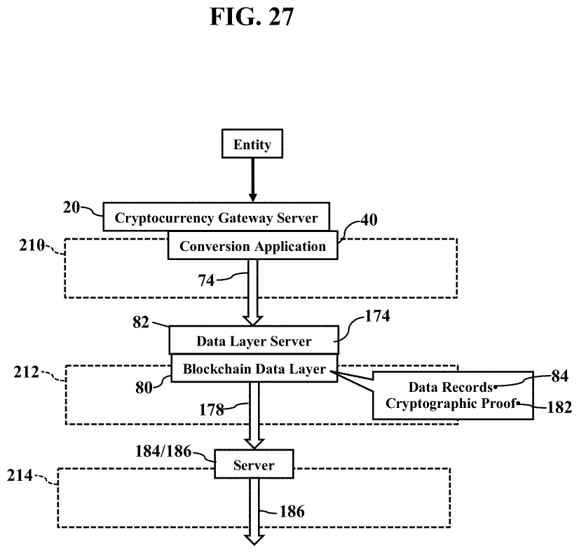

FIG. 27 illustrates hierarchical hashing. Any entity (such as the cryptocurrency network 26 and/or the user's smartphone 120 illustrated in FIG. 15) sends cryptographic data to the cryptocurrency gateway server 20. The cryptocurrency gateway server 20, generating the blockchain 74, provides a first layer 210 of cryptographic hashing. The market server 74 may then send the blockchain 48 to the protocol server 72. The data layer server 82, executing the data layer application 174, generates the blockchain data layer 80. The data layer application 174 may optionally provide the second or intermediate layer 212 of cryptographic hashing to generate the cryptographic proof 182. The data layer application 174 may also publish any of the data records 84 as the public blockchain 178, and the cryptographic proof 182 may or may not also be published via the public blockchain 178. The public blockchain 178 and/or the cryptographic proof 182 may be optionally sent to any server 184/186 as an input to yet another public blockchain 186 (again, such as BITCOIN®, ETHEREUM®, or RIPPLE®) for a third layer 214 of cryptographic hashing and public publication. The first layer 210 and the second layer 212 thus ride or sit atop a conventional public blockchain 186 (again, such as BITCOIN®, ETHEREUM®, or RIPPLE®) and provide additional public and/or private cryptographic proofs 182.

Exemplary embodiments may use any hashing function. Many readers may be familiar with the SHA-256 hashing algorithm. The SHA-256 hashing algorithm acts on any electronic data or information to generate a 256-bit hash value as a cryptographic key. The key is thus a unique digital signature. There are many hashing algorithms, though, and exemplary embodiments may be adapted to any hashing algorithm.

The electronic database 150 permits fraud detection. The electronic database 150 may be queried to discover or confirm a previous, historical destruction operation 60. For example, when the cryptocurrency gateway server 20 and/or the data layer server 82 processes any cryptographic order or transaction (e.g., a buy/sell) associated with any cryptographic token 30 and/or 34, exemplary embodiments may first query the electronic database 150 for the corresponding token identifier. If an entry in the electronic database 150 associates the token identifier to the destruction operation 60, then exemplary embodiments may escalate the cryptographic order or transaction for a fraud review. In plain words, if the token identifier is associated with a previous or historical destruction operation 60, then the corresponding cryptographic token 30 and/or 34 may have already been destroyed in response to a previous or historical buy/sell order. The cryptographic token 30 and/or 34 may have already been tagged or processed for deletion or removal from the market exchange, so its market presence may indicate a potential fraudulent order. Regardless, if fraud is suspected or inferred, exemplary embodiments may delay or even halt processing of the cryptographic order or transaction for additional scrutiny.

The blockchain data layer 80 may also reveal fraudulent efforts. Again, when any cryptographic order or transaction specifies any transaction involving any cryptographic token 30 and/or 34, exemplary embodiments may additionally or alternatively query the data records 84 in the blockchain data layer 80 for the corresponding token identifier. If any data record 84 contains a matching token identifier, the data record 84 may be retrieved and read/inspected for the destruction operation 60. If the data record 84 logs the destruction operation 60, then exemplary embodiments may infer that some party or market participant is attempting to buy/sell/convert a dead, destroyed, or uncirculated token.

Exemplary embodiments may thus track circulation of cryptographic tokens. Any token identifier (or its hash value) may be compared to the entries in the electronic database 150 and/or to the blockchain data layer 80. Suppose, for example, the electronic database 150 only contains entries for active cryptographic token 30 and/or 34. That is, the electronic database 150 may only have entries for the cryptographic token 30 and/or 34 that are approved for trading in the market exchange. The token identifiers of inactive or destroyed tokens, in other words, may not be logged in the electronic database 150. If the token identifier fails to match an entry in the electronic database 150, then exemplary embodiments may infer that the corresponding token 30 and/or 34 is not authorize for trades and/or was previously destroyed.

Exemplary embodiments may include a cloud-based blockchain service provided by a cloud service provider. When the creation operation 50 or the destruction operation 60 is needed, the cryptocurrency gateway server 20 may outsource or subcontract the creation operation 50 or the destruction operation 60 to the cloud service provider. The cryptocurrency gateway server 20, for example, may generate and send a service request via the communications network 126 to the network address (such as an Internet protocol address) associated with a service server that provides the creation operation 50 or the destruction operation 60. The service request may include or specify any transactional details associated with any cryptographic order or transaction (such as token identifer(s), user identifier(s), quantity, exchange rate 102, pricing/value 106). The cloud service provider acts on information in the service request and creates and/or destroys the tokens 30 and/or 34. The cloud service provider may also inform the data layer server 82 of the creation operation 50 or the destruction operation 60 for recordation in the blockchain data layer 80. The cloud service provider may also generate a service response that is sent to the cryptocurrency gateway server 20. The service response may simply or comprehensively detail the creation operation 50 or the destruction operation 60. The cryptocurrency gateway server 20 and the cloud service provider may thus cooperate in a client/server fashion and cooperate to send, receive, and/or generate the service request, the service response, and/or the data records 84 in the blockchain data layer 80. A cryptographic fee may then be charged, assessed, or debited.

The user may thus buy/sell/trade multiple cryptographic coinages of differing types. Indeed, as more and more private and public entities offer cryptographic coins, the user's electronic wallet 110 may be linked or associated with many or even hundreds of different retailers', different service providers', and different governments cryptographic coins 30 and/or 34. Each cryptographic coin 30 and/or 34 may have its corresponding current exchange rate 102 and market value 106. Moreover, because the cryptographic tokens 30 and/or 34 may fluctuate in value, there may be multiple cryptographic exchange rates 102 when valuing/trading/converting between any of the cryptographic 30 and/or 34 (as earlier explained). Owners/Holders/Users may thus see trade/convert/sell opportunities to reap a profit. Any of the cryptographic tokens 30 and/or 34 may be exchanged between any other, and/or to any other asset, according to their relative cryptographic exchange rates 102.

Users may thus conduct trades. The user may open and make cryptographic transactions using her electronic wallet 110. The electronic wallet 110 is and/or the user's device (such as the smartphone 120) is/are registered and/or authorized to submit transactions/orders. The user's smartphone 120 has a hardware processor that executes the electronic wallet 110 stored in a memory device. The electronic wallet 110 may be associated with, or configured with, the single account address 112. The single account address 112 may thus be associated with, or related to, values or holdings in each one of the multiple cryptographic tokens 30 and/or 34. Their individual price or market values 106 determines how conversions are performed, whether executed by the cryptocurrency gateway server 20 and/or by the electronic wallet 110. The single account or address 112 may thus be a cryptographic key to each one of their cryptographic holdings or buckets. The cryptographic key, in other words, may be related to the market values 106 or holdings in each cryptographic token 30 and/or 34.

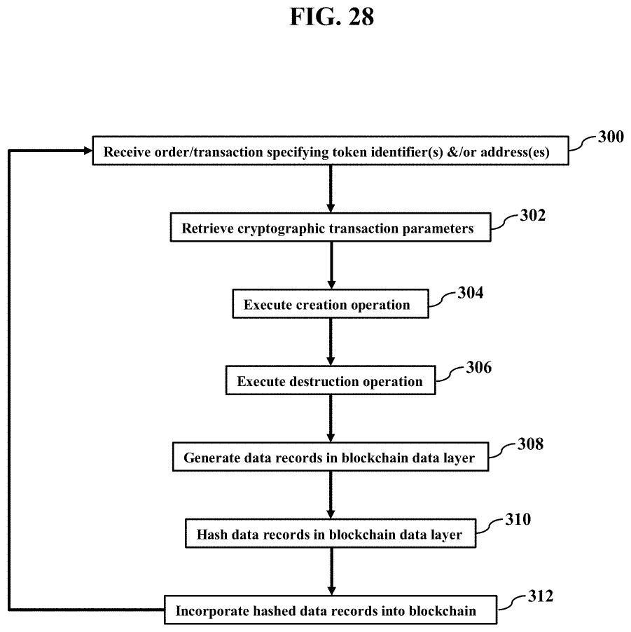

FIG. 28 is a flowchart illustrating a method or algorithm for converting cryptographic assets. An electronic order or transaction is received that specifies one or multiple token identifiers and/or addresses (Block 300). Transaction parameters (e.g., quantity, exchange rate(s) 102, and pricing/value 106) are retrieved (Block 302). The creation operation 50 is performed according to the transaction parameters (Block 304). The destruction operation 60 is performed according to the transaction parameters (Block 306). The data records 84 in the blockchain data layer 80 are generated (Block 308). The data records 84 may be hashed (Block 310) and incorporated into the public blockchain 178 (Block 312).

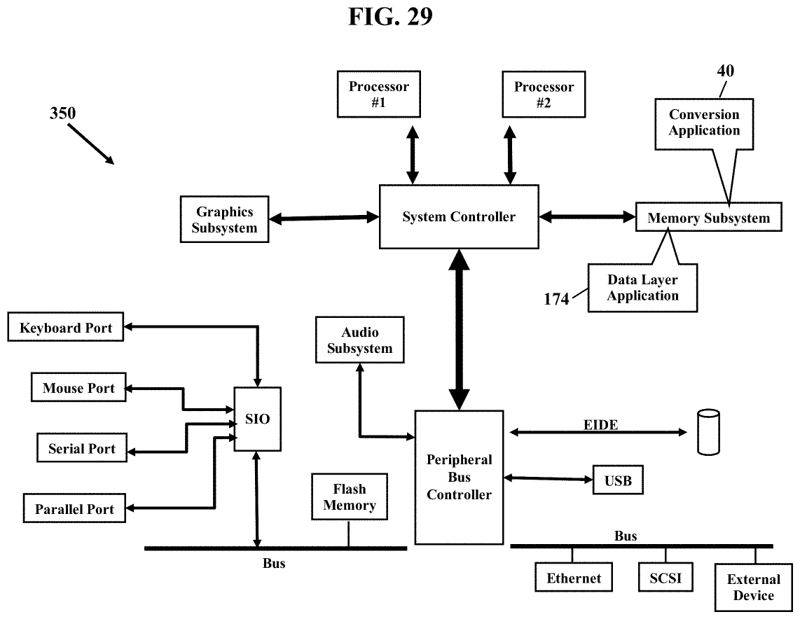

FIG. 29 is a schematic illustrating still more exemplary embodiments. FIG. 29 is a more detailed diagram illustrating a processor-controlled device 350. As earlier paragraphs explained, the conversion application 40 and the data layer application 174 may partially or entirely operate in any mobile or stationary processor-controlled device. FIG. 29, then, illustrates the conversion application 40 and the data layer application 174 stored in a memory subsystem of the processor-controlled device 350. One or more processors communicate with the memory subsystem and execute either, some, or all applications. Because the processor-controlled device 350 is well known to those of ordinary skill in the art, no further explanation is needed.

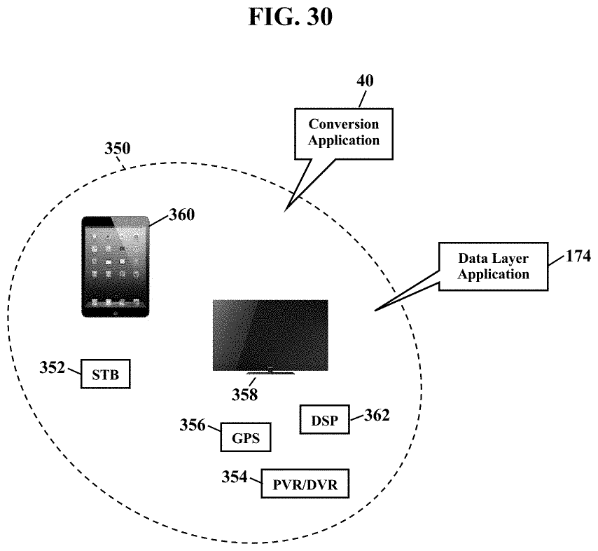

FIG. 30 depicts other possible operating environments for additional aspects of the exemplary embodiments. FIG. 30 illustrates the conversion application 40 and the data layer application 174 operating within various other processor-controlled devices 350. FIG. 30, for example, illustrates that the conversion application 40 and the data layer application 174 may entirely or partially operate within a set-top box (“STB”) or other media player (352), a personal/digital video recorder (PVR/DVR) 354, a Global Positioning System (GPS) device 356, an interactive television 358, a tablet computer 360, or any computer system, communications device, or processor-controlled device utilizing any of the processors above described and/or a digital signal processor (DP/DSP) 362. Moreover, the processor-controlled device 350 may also include wearable devices (such as watches), radios, vehicle electronics, cameras, clocks, printers, gateways, mobile/implantable medical devices, and other apparatuses and systems. Because the architecture and operating principles of the various devices 350 are well known, the hardware and software componentry of the various devices 350 are not further shown and described.

Exemplary embodiments may be applied to any signaling standard. Most readers are thought familiar with the Global System for Mobile (GSM) communications signaling standard. Those of ordinary skill in the art, however, also recognize that exemplary embodiments are equally applicable to any communications device utilizing the Time Division Multiple Access signaling standard, the Code Division Multiple Access signaling standard, the “dual-mode” GSM-ANSI Interoperability Team (GAIT) signaling standard, or any variant of the GSM/CDMA/TDMA signaling standard. Exemplary embodiments may also be applied to other standards, such as the I.E.E.E. 802 family of standards, the Industrial, Scientific, and Medical band of the electromagnetic spectrum, BLUETOOTH and any other.

Exemplary embodiments may be physically embodied on or in a computer-readable non-transitory storage medium. This computer-readable medium, for example, may include CD-ROM, DVD, tape, cassette, floppy disk, optical disk, memory card, memory drive, and large-capacity disks. This computer-readable medium, or media, could be distributed to end-subscribers, licensees, and assignees. A computer program product comprises processor-executable instructions for conversion of cryptographic coins, as the above paragraphs explain.

While the exemplary embodiments have been described with respect to various features, aspects, and embodiments, those skilled and unskilled in the art will recognize the exemplary embodiments are not so limited. Other variations, modifications, and alternative embodiments may be made without departing from the spirit and scope of the exemplary embodiments.

1. A method of converting cryptographic currencies, comprising:
receiving, by a server, a cryptographic coinage transaction associated with an electronic wallet, the cryptographic coinage transaction specifying a cryptographic token associated with a network of cryptographic tokens to be converted into a different cryptographic token associated with a different network of cryptographic tokens;
executing, by the server, a destruction operation in response to the cryptographic coinage transaction associated with the electronic wallet, the destruction operation destroying the cryptographic token associated with the network of cryptographic tokens; and
executing, by the server, a creation operation in response to the cryptographic coinage transaction associated with the electronic wallet, the creation operation creating the different cryptographic token associated with the different network of cryptographic tokens.

2. The method of claim 1, further comprising retrieving a cryptocurrency exchange rate associated with the cryptographic token and the different cryptographic token.

3. The method of claim 1, further comprising retrieving a value associated with the cryptographic token.

4. The method of claim 1, further comprising retrieving a value associated with the different cryptographic token.

5. The method of claim 1, further comprising logging the destruction operation.

6. The method of claim 1, further comprising logging the creation operation.

7. The method of claim 1, further comprising storing an association between the cryptographic coinage transaction and the destruction operation.

8. The method of claim 1, further comprising storing an association between the cryptographic coinage transaction and the creation operation.

9. A system, comprising:
a hardware processor; and
a memory device, the memory device storing instructions, the instructions when executed causing the hardware processor to perform operations, the operations comprising:
receiving a cryptographic coinage transaction sent from a user's device to a cryptocurrency gateway server, the cryptographic coinage transaction associated with an electronic wallet, the cryptographic coinage transaction requesting a conversion of a first cryptographic token associated with a first network of cryptographic tokens into a second cryptographic token associated with a second network of cryptographic tokens;
receiving the first cryptographic token sent from the first network of cryptographic tokens to the cryptocurrency gateway server;
executing a destruction operation by the cryptocurrency gateway server in response to the receiving of the first cryptographic token, the destruction operation removing the first cryptographic token from the first network of cryptographic tokens and diverting the first cryptographic token to a private reserve controlled by the cryptocurrency gateway server;
retrieving the second cryptographic token associated with the second network of cryptographic tokens from the private reserve controlled by the cryptocurrency gateway server; and
executing a creation operation by the cryptocurrency gateway server that links the second cryptographic token retrieved from the private reserve to the second network of cryptographic tokens.

10. The system of claim 9, wherein the operations further comprise retrieving a cryptocurrency exchange rate associated with the first cryptographic token and the second cryptographic token.

11. The system of claim 9, wherein the operations further comprise retrieving a value associated with the first cryptographic token.

12. The system of claim 9, wherein the operations further comprise retrieving a value associated with the second cryptographic token.

13. The system of claim 9, wherein the operations further comprise logging the destruction operation.

14. The system of claim 9, wherein the operations further comprise logging the creation operation.

15. The system of claim 9, wherein the operations further comprise storing an association between the cryptographic coinage transaction and the destruction operation.

16. The system of claim 9, wherein the operations further comprise storing an association between the cryptographic coinage transaction and the creation operation.

17. A memory device storing instructions that, when executed by a hardware processor, facilitate performance of operations, the operations comprising:
receiving a cryptographic coinage transaction sent from a user's device to a cryptocurrency gateway server, the cryptographic coinage transaction associated with a source address representing a source electronic wallet, the cryptographic coinage transaction requesting a conversion of a first cryptographic token associated with a first network of cryptographic tokens into a second cryptographic token associated with a second network of cryptographic tokens;
receiving the first cryptographic token sent to the cryptocurrency gateway server from the source address representing the source electronic wallet associated with the first network of cryptographic tokens;
converting the first cryptographic token by the cryptocurrency gateway server into the second cryptographic token associated with the second network of cryptographic tokens according to a cryptographic exchange rate; and
associating the second cryptographic token converted from the first cryptographic token to a destination address representing a destination electronic wallet that matches the source address representing the source electronic wallet.

18. The memory device of claim 17, wherein the operations further comprise executing a destruction operation by the cryptocurrency gateway server that removes the first cryptographic token from the first network of cryptographic tokens and diverts the first cryptographic token to a private reserve controlled by the cryptocurrency gateway server.

19. The memory device of claim 17, wherein the operations further comprise executing a creation operation by the cryptocurrency gateway server that moves the second cryptographic token from the private reserve to the destination address representing the destination electronic wallet that matches the source address representing the source electronic wallet.

20. The memory device of claim 17, wherein the operations further comprise retrieving the cryptocurrency exchange rate.
